(19) United States
(12) Patent Application Publication
(10) Pub. No.: US 2014/0338606 A1
(43) Pub. Date: Nov. 20, 2014

(54) ABSORBENT SHEET FOR PETS

(71) Applicant: Uni-Charm Corporation, Ehime (JP)

(72) Inventors: Chiyo Takagi, Kagawa (JP); Takeshi Ikegami, Kagawa (JP)

(21) Appl. No.: 14/278,289

(22) Filed: May 15, 2014

(30) Foreign Application Priority Data
May 17, 2013 (JP) 2013-105644

(51) Int. Cl. A01K 1/015

(52) U.S. Cl. CPC A01K 1/0157
USPC 119/161

(57) ABSTRACT

A pet absorbent sheet having an excretion surface on which a pet excretes and a placing surface opposite to the excretion surface. The placing surface has an adhesive applied thereto and an adhesion region which can adhere to a placing object, and the adhesion region has a first adhesion region and a second adhesion region. The pet absorbent sheet further has a guiding part which covers the first and second adhesion regions and is provided such that the first and second adhesion regions are exposed in predetermined order.

### TECHNICAL FIELD OF THE INVENTION

The present invention relates to an absorbent sheet for pets.

### BACKGROUND OF THE INVENTION

Conventionally, an absorbent sheet for pets is used particularly for disposing of excrement of pets which are kept indoors. Various structures of absorbent sheet for pets have been provided. An example of an absorbent sheet for pets is disclosed in Japanese laid-open Patent Publication No. 2003-325068.

This known absorbent sheet for pets is attached to a placing object such as floor by a double-faced adhesive tape. Structurally, however, this pet absorbent sheet cannot be attached to a placing object in different manners depending on the kind of the placing object (flooring).
Patent Document 1: Japanese non-examined laid-open Patent Publication No 2003-325068.

### SUMMARY OF THE INVENTION

Accordingly, it is an object of the present invention to provide an improved technique for rationally constructing an absorbent sheet for pets.

In order to solve the above-described problem, according to a preferred aspect of the present invention, a pet absorbent sheet includes a liquid-permeable first sheet, a liquid-impermeable second sheet, an absorbing core disposed between the first sheet and the second sheet, an excretion surface on which a pet excretes, and a placing surface opposite to the excretion surface.

The placing surface has an adhesion region which has an adhesive applied thereto and can adhere to a placing object, and the adhesion region has a first adhesion region and a second adhesion region formed in a different manner from the first adhesion region.

The pet absorbent sheet further includes a guiding part which covers the first and second adhesion regions and is provided such that the first and second adhesion regions are exposed in predetermined order.

By such provision of the guiding part, the user can easily select a desired adhesive force for adhesion to a placing object, so that the pet absorbent sheet according to this invention can be provided with improved usability.

According to a further aspect of this invention, adhesive force in the first adhesion region is rendered weaker than adhesive force in the second adhesion region. Thus, the first adhesion region is formed in a different manner from the second adhesion region.

By such provision of a predetermined difference between the adhesive forces in the first and second adhesion regions, the usability can be further improved.

According to a further aspect of this invention, the guiding part is configured such that the first adhesion region is exposed first and the second adhesion region is exposed next.

Specifically, when, for example, the first adhesion region has a weaker adhesive force than the second adhesion region as described above, the first adhesion region having a weaker adhesive force can be reliably exposed first. Therefore, the user can easily obtain a desired adhesive force.

According to a further aspect of this invention, the guiding part has a release sheet arranged on at least part of the adhesion region, and the release sheet has one side and the other side opposite to the one side.

According to a further aspect of this invention, the release sheet has an inhibiting region for inhibiting adhesion to the adhesion region. By provision of the inhibiting region, the release sheet attached to the adhesion region can be easily removed from the adhesion region.

According to a further aspect of this invention, the release sheet has a promoting region for promoting adhesion to the adhesion region. By provision of the promoting region, the release sheet can be prevented from being completely removed from the adhesion region even when the release sheet is removed from the adhesion region.

According to a further aspect of this invention, the pet absorbent sheet further includes a pet sheet folding part along which the pet absorbent sheet is folded between the first adhesion region and the second adhesion region. By provision of the pet sheet folding part, the entire pet absorbent sheet can be folded without folding the first adhesion region and the second adhesion region. Particularly in manufacturing and packaging the product, the pet absorbent sheet can be folded up compactly without hindering functions of this invention.

### EFFECT OF THE INVENTION

According to this invention, an improved technique for rationally constructing an absorbent sheet for pets can be provided.

### BRIEF DESCRIPTION OF THE DRAWINGS

FIG. 1 is a perspective view showing a basic structure of a pet absorbent sheet according to the present invention.

FIG. 2 is a front view showing the basic structure of the pet absorbent sheet according to the present invention.

FIG. 3 is a bottom view showing the basic structure of the pet absorbent sheet according to the present invention.

FIG. 4 is a perspective view of a release sheet.

FIG. 5 is a sectional view taken along line VII-VII in FIG. 5.

FIG. 6 is a bottom view showing the pet absorbent sheet according to the present invention.

FIG. 7 is an explanatory drawing of a pet absorbent sheet according to a first embodiment pattern of the present invention.

FIG. 8 is an explanatory drawing of the pet absorbent sheet according to the first embodiment pattern of the present invention.

FIG. 9 is an explanatory drawing of the pet absorbent sheet according to the first embodiment pattern of the present invention.

FIG. 10 is an explanatory drawing of the pet absorbent sheet according to the first embodiment pattern of the present invention.

FIG. 11 is an explanatory drawing of a pet absorbent sheet according to a second embodiment pattern of the present invention.

FIG. 12 is an explanatory drawing of the pet absorbent sheet according to the second embodiment pattern of the present invention.

FIG. 13 is an explanatory drawing of the pet absorbent sheet according to the second embodiment pattern of the present invention.

FIG. 14 is an explanatory drawing of the pet absorbent sheet according to the second embodiment pattern of the present invention.

FIG. 15 is an explanatory drawing of a pet absorbent sheet according to a third embodiment pattern of the present invention.

FIG. 16 is an explanatory drawing of the pet absorbent sheet according to the third embodiment pattern of the present invention.

FIG. 17 is an explanatory drawing of the pet absorbent sheet according to the third embodiment pattern of the present invention.

FIG. 18 is an explanatory drawing of a pet absorbent sheet according to a fourth embodiment pattern of the present invention.

FIG. 19 is an explanatory drawing of the pet absorbent sheet according to the fourth embodiment pattern of the present invention.

FIG. 20 is an explanatory drawing of the pet absorbent sheet according to the fourth embodiment pattern of the present invention.

FIG. 21 is an explanatory drawing of the pet absorbent sheet according to a fifth embodiment pattern of the present invention.

FIG. 22 is an explanatory drawing of the pet absorbent sheet according to the fifth embodiment pattern of the present invention.

FIG. 23 is an explanatory drawing of the pet absorbent sheet according to the fifth embodiment pattern of the present invention.

FIG. 24 is an explanatory drawing of the pet absorbent sheet according to the fifth embodiment pattern of the present invention.

FIG. 25 is an explanatory drawing of a pet absorbent sheet according to a sixth embodiment pattern of the present invention.

FIG. 26 is an explanatory drawing of a pet absorbent sheet according to a seventh embodiment pattern of the present invention.

FIG. 27 is an explanatory drawing of the pet absorbent sheet according to the seventh embodiment pattern of the present invention.

FIG. 28 is an explanatory drawing of a pet absorbent sheet according to an eighth embodiment pattern of the present invention.

FIG. 29 is an explanatory drawing of the pet absorbent sheet according to the eighth embodiment pattern of the present invention.

### DETAILED DESCRIPTION OF THE INVENTION

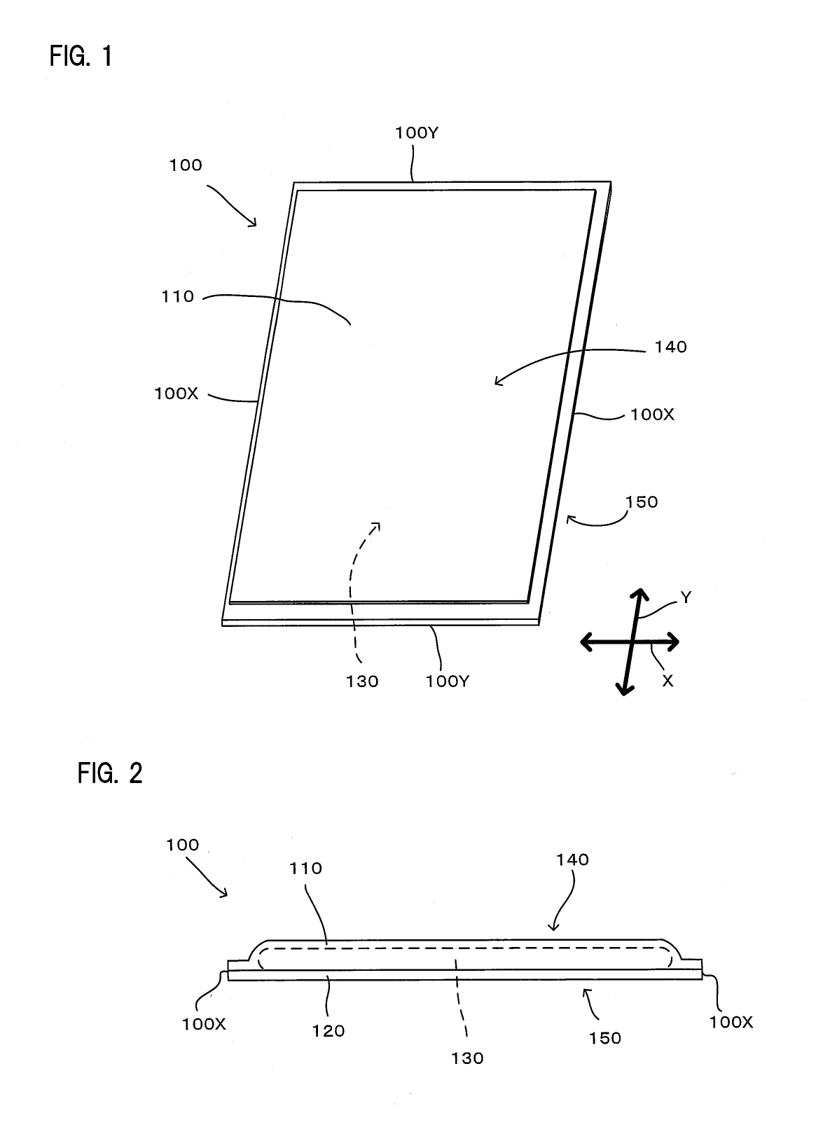

A pet absorbent sheet according to the present invention is described hereinbelow with reference to FIGS. 1 to 29. An “animal” here widely includes vertebrates (mammals, reptiles, birds and amphibians) and invertebrates, but typically represents pets such as cats, dogs, rabbits and hamsters.

### (General Basic Structure)

The basic structure of a pet absorbent sheet according to this invention is now explained with reference to FIGS. 1 to 6.

A pet absorbent sheet 100 includes a liquid-permeable top sheet 110, a liquid-impermeable back sheet 120, and an absorbing core 130 disposed between the top sheet 110 and the back sheet 120. The pet absorbent sheet 100 here is a feature that corresponds to the “pet absorbent sheet” according to this invention. The top sheet 110, the back sheet 120 and the absorbing core 130 here are features that correspond to the “first sheet”, the “second sheet” and the “absorbing core”, respectively, according to this invention.

The pet absorbent sheet 100 is a flat sheet having a predetermined thickness. The pet absorbent sheet 100 is spread out flat with the back sheet 120 on an intended or desired place (placing object). This state is a pet use mode for receiving excrement of pets. The “excrement of pets” here widely includes not only urine, but body fluids such as saliva and menstrual blood.

In the pet use mode, the top sheet 110 forms an excretion surface 140 on which a pet excretes. The back sheet 120 has a placing surface 150 which is formed on the side opposite to the excretion surface 140 and placed on a placing object (intended place). The excretion surface 140 and the placing surface 150 are features that correspond to the “excretion surface” and the “placing surface”, respectively, according to this invention.

The manner in which the placing surface 150 is placed on the “placing object” includes a manner in which the pet absorbent sheet 100 is directly placed on floor or the like, and a manner in which the pet absorbent sheet 100 is set on a holder and placed on floor or the like.

The floor on which the pet absorbent sheet 100 is placed may be made of various materials with various structures. For example, synthetic resin such as vinyl and linoleum, wood coated with wax or oil, uncoated wood, vegetable fibers represented by tatami mat, or fibers with or without loops may be used.

The top sheet 110, the back sheet 120 and the absorbing core 130 may each have a structure and arrangement appropriately selected from those of known pet absorbent sheets, and therefore, for the sake of expedience, their description is omitted.

The top sheet 110 may be formed of thermoplastic nonwoven fabric, including spun-bond nonwoven fabric of thermoplastic long fibers, air-through nonwoven fabric of thermoplastic short fibers, point-bond nonwoven fabric and perforated film.

The back sheet 120 may be preferably formed particularly by a resin film sheet in order to ensure its liquid-impermeability. For example, a film of polyethylene, polypropylene or polyethylene terephthalate may be used to form the back sheet 120. Further, in consideration of flexibility, the back sheet 120 may be formed by a nonwoven fabric to which a water repellent is applied.

The absorbing core 130 may be formed of a mixture of granular or fibrous high-absorbent polymers and fluff pulp, or a mixture of granular or fibrous high-absorbent polymers, fluff pulp and thermoplastic rigid resin fibers.

The pet absorbent sheet 100 preferably has a rectangular or square shape, but it may have a circular, elliptical or polygonal shape.

The pet absorbent sheet 100 according to this invention is rectangular and extends in a longitudinal direction Y and a lateral direction X transverse to the longitudinal direction Y. The pet absorbent sheet 100 has a pair of longitudinal ends 100Y in the longitudinal direction Y and a pair of lateral ends 100X in the lateral direction X.

In the case of the pet absorbent sheet 100 having a complete round shape in which the longitudinal direction Y cannot be identified, one direction in the pet absorbent sheet 100 may be defined as the longitudinal direction Y and the other direction transverse to the longitudinal direction Y may be defined as the lateral direction X.

The placing surface 150 of the pet absorbent sheet 100 has an adhesion region 200 which can adhere to a placing object. The adhesion region 200 has a first adhesion region 210 and a second adhesion region 220. The first adhesion region 210 is formed in a different manner from the second adhesion region 220. The adhesion region 200, the first adhesion region 210 and the second adhesion region 220 are features that correspond to the “adhesion region”, the “first adhesion region” and the “second adhesion region”, respectively, according to this invention.

The adhesive force in the first adhesion region 210 is rendered weaker than that in the second adhesion region 220. Thus, the first adhesion region 210 is formed in a different manner from the second adhesion region 220.

The “adhesive force” in this invention includes not only a force to fix the adhesion region 200 to a placing object, but a force to separate the pet absorbent sheet 100 with the placing surface 150 attached to the placing object by the adhesion region 200, from the placing object. Specifically, the adhesive force includes a force to separate the attached pet absorbent sheet by vertically pulling it up off the placing object, and a force to separate the attached pet absorbent sheet by holding an end (the longitudinal end 100Y or the lateral end 100X) of the pet absorbent sheet and pulling it obliquely upward.

In order to determine whether the adhesive force is weak or strong, it is necessary to consider the relative relation between the adhesion region 200 and the placing object. When, for example, one of the adhesion regions 200 has one adhesive 230 and the other adhesion region 200 has another adhesive 230 as described below, and the placing object is flat and smooth like vinyl flooring, the one adhesion region 200 is provided to have a stronger adhesive force. Therefore, in this case, the other adhesion region 200 having the hooks 241 forms the first adhesion region 210, and the one adhesion region 200 having the adhesive 230 forms the second adhesion region 220. On the other hand, when the placing object is flooring having fiber loops, the other adhesion region 200 is provided to have a stronger adhesive force. Therefore, in this case, the one adhesion region 200 having the one adhesive 230 forms the first adhesion region 210, and the other adhesion region 200 having the other adhesive 230 forms the second adhesion region 220. The adhesives 230 are features that correspond to the “adhesive” according to this invention.

Further, for example, the one adhesion region 200 and the other adhesion region 200 may have the same adhesive force to one placing object. Even in such a case, if they have different adhesive forces to the other placing object, the first adhesion region 210 and the second adhesion region 220 are accordingly formed.

Further, for example, the one adhesion region 200 may have a stronger separation force in a vertical direction, but have a weaker separation force in an obliquely upward direction than the other adhesion region 200. In such a case, the first adhesion region 210 and the second adhesion region 220 are accordingly formed in each situation of separation.

For convenience of explanation, in this specification, the first and second adhesion regions 210, 220 may be explained and illustrated in the drawings without particularly considering the above-described relation with the materials and structure of the flooring.

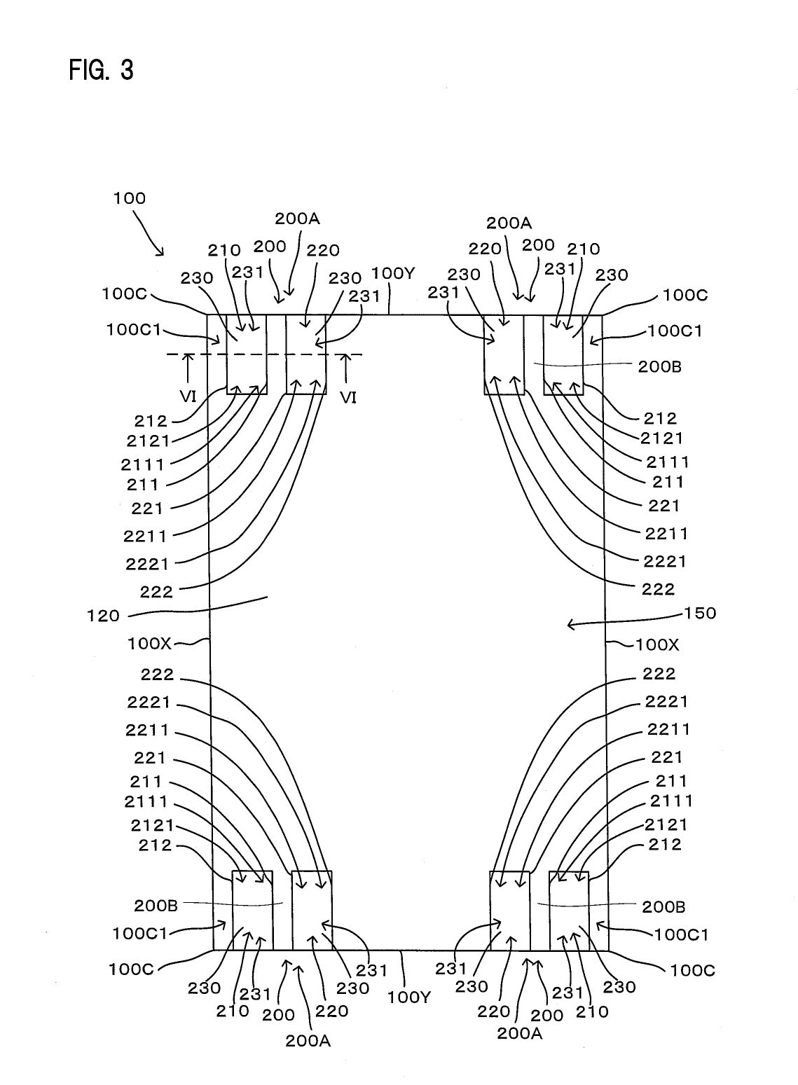

In the pet absorbent sheet 100 shown in FIG. 3, the first adhesion regions 210 and the second adhesion regions 220 have the adhesive 230. Thus, the adhesion region 200 is formed by an adhesive region 231 having the adhesive 230 applied thereto. The adhesive region 231 is a feature that corresponds to the “adhesive region” according to this invention.

The adhesive 230 may be a rubber, acrylic elastomer or acrylic resin adhesive. Or the adhesive 230 may be an ethylene-vinyl acetate copolymer (EVA) or polyolefin hot-melt adhesive. Further, the adhesive 230 may be an adhesive having a tackifier such as terpene resin. The adhesive 230 may be designed not only to fix the pet absorbent sheet 100 to the placing object by the adhesive force, but it may be only necessary to have an effect of increasing the resistance against the placing object. Urethane resin is preferably used as the adhesive 230 which increases the resistance against the placing object.

A pair of the first and second adhesion regions 210, 220 adjacent to each other forms an adjacent adhesion region 200A. A plurality of such adjacent adhesion regions 200A are arranged on the placing surface 150 of the pet absorbent sheet 100. In the pet absorbent sheet 100, corner regions 100C1 are formed in regions where the longitudinal ends 100Y and the lateral ends 100X intersect with each other and form corners 100C. The adjacent adhesion regions 200A are arranged in the corner regions 100C1. The pet absorbent sheet 100 shown in FIG. 3 has a rectangular shape having four corner regions 100C1. The adjacent adhesion regions 200A are provided in all of the four corner regions 100C1.

An end of each adhesion region 200 coincides with an end of the pet absorbent sheet 100. In FIG. 3, each of the first and second adhesion regions 210, 220 forming the adhesion region 200 has an end in the longitudinal direction Y which is provided to coincide with the longitudinal end 100Y of the pet absorbent sheet 100. When the placing surface 150 of the pet absorbent sheet 100 is fixed on a placing object by the adhesion region 200, the longitudinal end 100Y of the pet absorbent sheet 100 is closely attached in the adhesion region 200 to the placing object. Thus, the longitudinal end 100Y of the pet absorbent sheet 100 in the adhesion region 200 can be prevented from being turned up by a pet.

The adhesive force in the first adhesion region 210 is rendered weaker than that in the second adhesion region 220. Specific examples of forming such a structure are described below.

For example, when the first adhesion region 210 and the second adhesion region 220 have the same area and have the adhesive 230 having the same composition, part of the adhesive region 231 may be subjected to embossing, or powder may be applied thereto, or the adhesive 230 may not be applied thereto.

When the first adhesion region 210 and the second adhesion region 220 have the adhesive 230 having the same composition, the first adhesion region 210 may be provided to have a smaller area than the second adhesion region 220.

Further, the adhesive 230 having a weaker adhesive force than that for the second adhesion region 220 may be applied to an area for the first adhesion region 210.

The adjacent adhesion region 200A has the first adhesion region 210 and the second adhesion region 220. A middle region 200B is formed between the first adhesion region 210 and the second adhesion region 220 in the adjacent adhesion region 200A. As shown in FIG. 3, the middle region 200B may be provided to be a region of the back sheet 120 to which the adhesive 230 is not applied. Further, when the first adhesion region 210 and the second adhesion region 220 are provided to be joined to each other, the middle region 200B is an interface between the first adhesion region 210 and the second adhesion region 220.

The structure of the first adhesion region 210 is now described based on the positional relation of the first adhesion region 210 and the second adhesion region 220 in the pet absorbent sheet 100 ready to be attached to a placing object (in pet use mode).

The first adhesion region 210 has an adjacent end 211 adjacent to the second adhesion region 220 across the middle region 200B. The first adhesion region 210 has a farther end 212 opposite to the adjacent end 211. The farther end 212 is an end farthest away from the second adhesion region 220 in the first adhesion region 210. In the first adhesion region 210, a region having the adjacent end 211 is an adjacent end region 2111, and a region having the farther end 212 is a farther end region 2121.

The structure of the second adhesion region 220 is now described based on the positional relation of the first adhesion region 210 and the second adhesion region 220 in the pet absorbent sheet 100 ready to be attached to a placing object (in pet use mode).

The second adhesion region 220 has an adjacent end 221 adjacent to the first adhesion region 210 across the middle region 200B. The second adhesion region 220 has a farther end 222 opposite to the adjacent end 221. The farther end 222 is an end farthest away from the first adhesion region 210 in the second adhesion region 220. In the second adhesion region 220, a region having the adjacent end 221 is an adjacent end region 2211, and a region having the farther end 222 is a farther end region 2221.

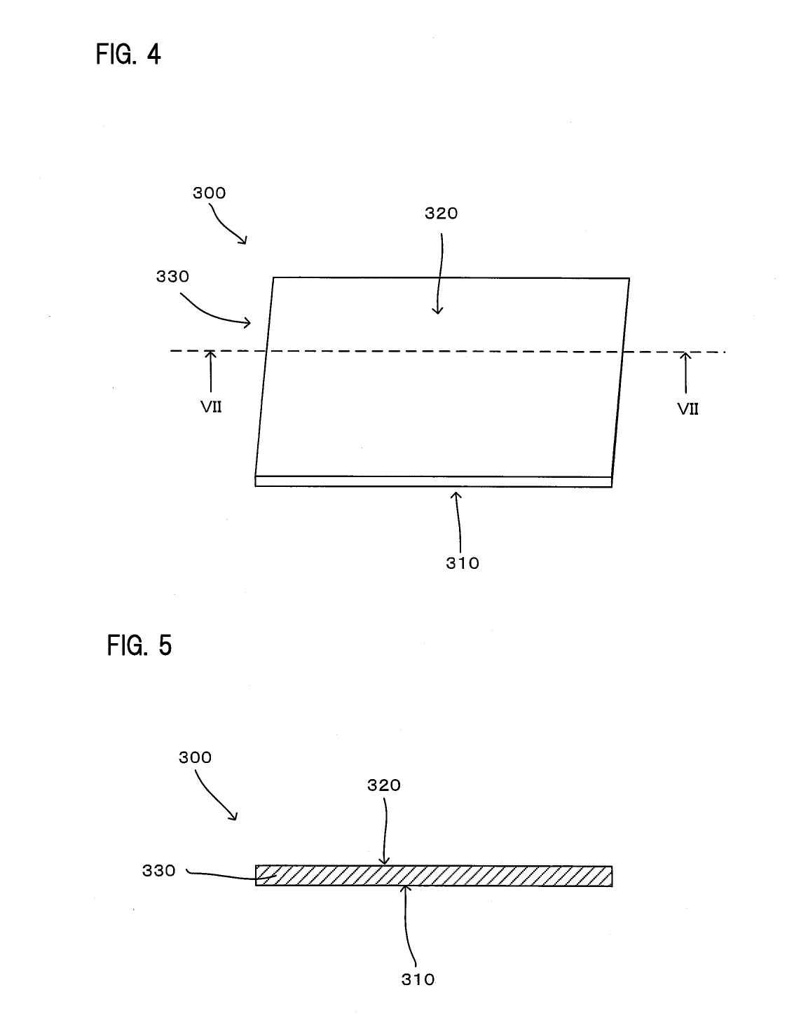

FIGS. 4 and 5 show a release sheet 300 which is provided on the adhesion region 200. The release sheet 300 includes a first release sheet surface 310 on one side and a second release sheet surface 320 on the other side. The release sheet 300, the first release sheet surface 310 and the second release sheet surface 320 are features that correspond to the “release sheet”, the “one side”, and the “other side”, respectively, according to this invention.

The release sheet 300 has a release sheet body 330. The release sheet body 330 is made of semi-bleached paper, high-quality paper, glassine paper or other similar paper.

The release sheet 300 has an inhibiting region 340 for inhibiting adhesion to the adhesion region 200 as described below. The inhibiting region 340 is a feature that corresponds to the “inhibiting region” according to this invention.

The inhibiting region 340 is made of silicon resin. Further, a filling layer, which is not shown, is provided between the release sheet body 330 and the inhibiting region 340 in order to prevent the release sheet body 330 from being impregnated with silicon resin of the inhibiting region 340. The filling layer is formed of polyethylene, clay coat, polyvinyl alcohol or other similar materials.

A promoting region 350 for promoting adhesion to the adhesion region 200 is formed in the release sheet 300 as described below. The promoting region 350 is a feature that corresponds to the “promoting region” according to this invention.

The promoting region 350 is formed by not providing the inhibiting region 340 in the release sheet body 330. Further, the promoting region 350 is formed by applying an adhesive to the release sheet body 330.

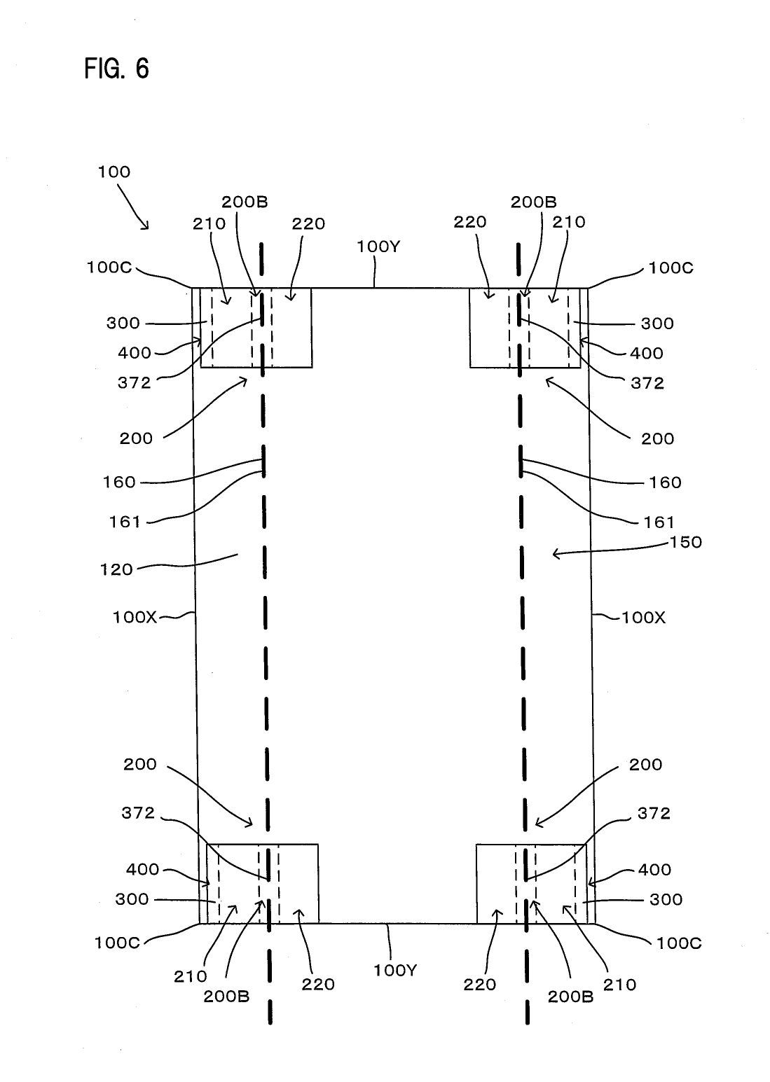

FIG. 6 shows the pet absorbent sheet 100 before use.

The pet absorbent sheet 100 before use has the release sheet 300 attached to the adhesion region 200. Therefore, in using the pet absorbent sheet 100, the release sheet 300 is removed from the adhesion region 200 by a user. Then the adhesion region 200 is attached to a placing object so that the pet absorbent sheet 100 is fixed to the placing object.

A guiding part 400 which is described below is provided and formed such that the first and second adhesion regions 210, 220 are exposed in predetermined order when the release sheet 300 is removed from the adhesion region 200. At this time, preferably, the guiding part 400 is provided and formed such that the first adhesion region 210 is exposed first and then the second adhesion region 220 is exposed. The guiding part 400 is formed by the structure of the release sheet 300 itself or combination of the release sheet 300 and other structure. The guiding part 400 is a feature that corresponds to the “guiding part” according to this invention.

FIG. 6 shows the pet absorbent sheet 100 before use. The pet absorbent sheet 100 is left folded along an entire folding line 160 just after being taken out of a package. The entire folding line 160 is arranged along the longitudinal direction Y to pass through the middle region 200B of the adhesion region 200. Therefore, when the release sheet 300 is provided over the first adhesion region 210 and the second adhesion region 220, the release sheet 300 is also folded together with the pet absorbent sheet 100 along the entire folding line 160. Specifically, when the release sheet 300 is provided over the first adhesion region 210 and the second adhesion region 220, the entire folding line 160 forms a pet sheet folding part 161 in the pet absorbent sheet 100 and a release sheet middle folding part 372 in the release sheet 300. The pet sheet folding part 161 is a feature that corresponds to the “pet sheet folding part” according to this invention.

When the release sheet 300 is provided to have an area enough to cover only one of the first adhesion region 210 and the second adhesion region 220, the release sheet middle folding part 372 may not be formed in the release sheet 300. In such a case, the entire folding line 160 forms only the pet sheet folding part 161.

Further, when the pet absorbent sheet 100 is packed in a package, the pet absorbent sheet 100 may be folded along not only the entire folding line 160 but any other folding line.

When removing the release sheet 300, the user can appropriately select the adhesive force between the pet absorbent sheet 100 and the placing object.

Specifically, when greater importance is placed on ease of removal of the pet absorbent sheet 100 from the placing object, the guiding part 400 is provided and formed such that only the first adhesion region 210 is exposed in the adhesion region 200. In this case, the release sheet 300 on the first adhesion region 210 is removed from the adhesion region 200, and the first adhesion region 210 is attached to the placing object.

When greater importance is placed on the fixing strength between the pet absorbent sheet 100 and the placing object, the guiding part 400 is provided and formed such that both the first and second adhesion regions 210, 220 are exposed in the adhesion region 200. In this case, the release sheet 300 on the second adhesion region 220 is removed from the adhesion region 200, and the first and second adhesion regions 210, 220 are fixed to the placing object.

In the pet absorbent sheet 100 according to this invention, as described above, the pet absorbent sheet 100 can be fixed to the placing object with a desired adhesive force. Therefore, the pet absorbent sheet 100 can be provided with improved usability.

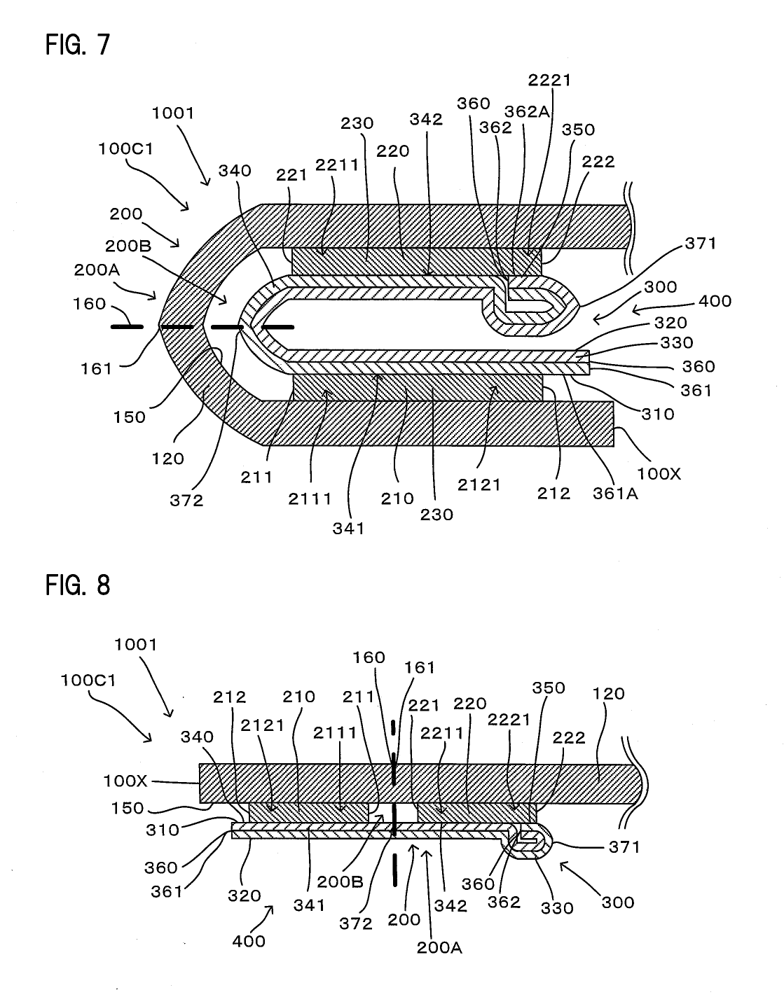

Now first to eighth embodiment patterns according to this invention are explained with reference to FIGS. 7 to 29. In the explanation of the embodiment patterns, component elements identical or corresponding to those in the above-described pet absorbent sheet 100 having the basic structure, or to those in other embodiment patterns are given like numerals and are not described.

### First Basic Structure

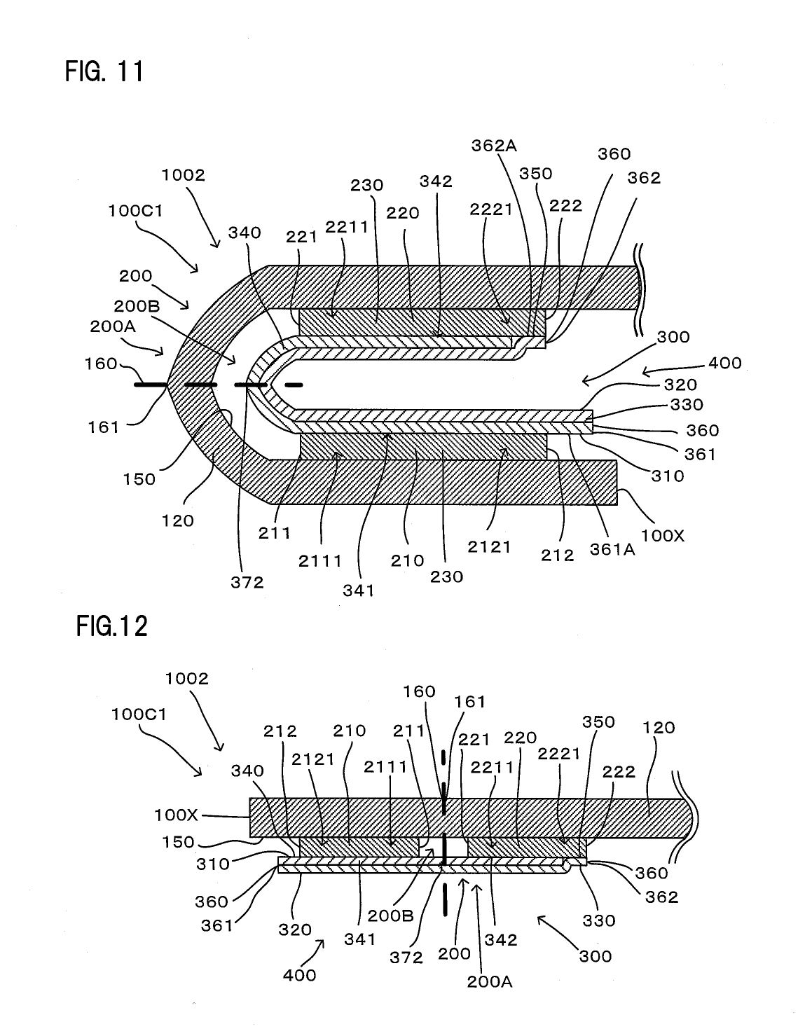

Referring to FIGS. 7 to 14, a first basic structure is explained. The specific structure of the first basic structure is described based on the first and second embodiment patterns. FIGS. 7 to 10 are explanatory drawings illustrating the first embodiment pattern, and FIGS. 11 to 14 are explanatory drawings illustrating the second embodiment pattern.

First, features of the first basic structure common to the first and second embodiment patterns are explained.

In the first basic structure, the release sheet 300 which forms the guiding part 400 is provided to have an area enough to cover both the first adhesion region 210 and the second adhesion region 220. The release sheet 300 has the inhibiting region 340 on the first release sheet surface 310. In the release sheet 300 attached to the adhesion region 200, the inhibiting region 340 has a first inhibiting region 341 which is removably attached to the first adhesion region 210, and a second inhibiting region 342 which is removably attached to the second adhesion region 220.

The release sheet 300 is thus provided and configured to form the guiding part 400 such that the first inhibiting region 341 is first removed from the first adhesion region 210 and then the second inhibiting region 342 is removed from the second adhesion region 220.

The release sheet 300 further has the promoting region 350. The promoting region 350 is formed in a region of the release sheet 300 which is attached to the second adhesion region 220.

The release sheet 300 further has a part extending beyond the farther end 212 of the first adhesion region 210.

The release sheet 300 has ends 360 opposite to each other. One of the ends 360 in a region of the promoting region 350 forms a fixed end 362. The other end in the part extending beyond the farther end 212 of the first adhesion region 210 forms a removal starting end 361.

A region of the release sheet 300 including the fixed end 362 is a fixed region 362A. The fixed region 362A has the promoting region 350.

Further, a region of the release sheet 300 including the removal starting end 361 is a removal starting region 361A. The removal starting region 361A has the part of the release sheet 300 extending beyond the farther end 212 of the first adhesion region 210.

The release sheet 300 has the release sheet middle folding part 372 formed by the entire folding line 160. The release sheet middle folding part 372 is formed in the middle region 200B between the first adhesion region 210 and the second adhesion region 220. In the release sheet 300, the release sheet middle folding part 372 is an interface between the first inhibiting region 341 and the second inhibiting region 342. The release sheet middle folding part 372 is a feature that corresponds to the “release sheet middle folding part” according to this invention.

### First Embodiment Pattern

Referring to FIGS. 7 to 10, a pet absorbent sheet 1001 according to the first embodiment pattern is now explained. FIG. 7 is an enlarged sectional view showing the adhesion region 200 just after the pet absorbent sheet 1001 is taken out of a package by a user. The pet absorbent sheet 1001 is left folded along the entire folding line 160.

In the release sheet 300 on the pet absorbent sheet 1001, the promoting region 350 is provided in a region of the second release sheet surface 320 on the second inhibiting region 342 side. The promoting region 350 is attached to the farther end region 2221 of the second adhesion region 220.

The release sheet 330 is folded back along a first release sheet folding part 371. The first release sheet folding part 371 is formed near the farther end 222 of the second adhesion region 220 in the release sheet 300 and outside the fixed region 362A. Thus, the first release sheet surface 310 of the release sheet 300 faces the adhesion region 200.

When using the pet absorbent sheet 1001, as shown in FIG. 8, the pet absorbent sheet 1001 is unfolded along the entire folding line 160.

Then the user holds the removal starting end 361 and removes the first inhibiting region 341 of the release sheet 300 from the first adhesion region 210. In such removal of the first inhibiting region 341 from the first adhesion region 210, the user can also hold the removal starting region 361A.

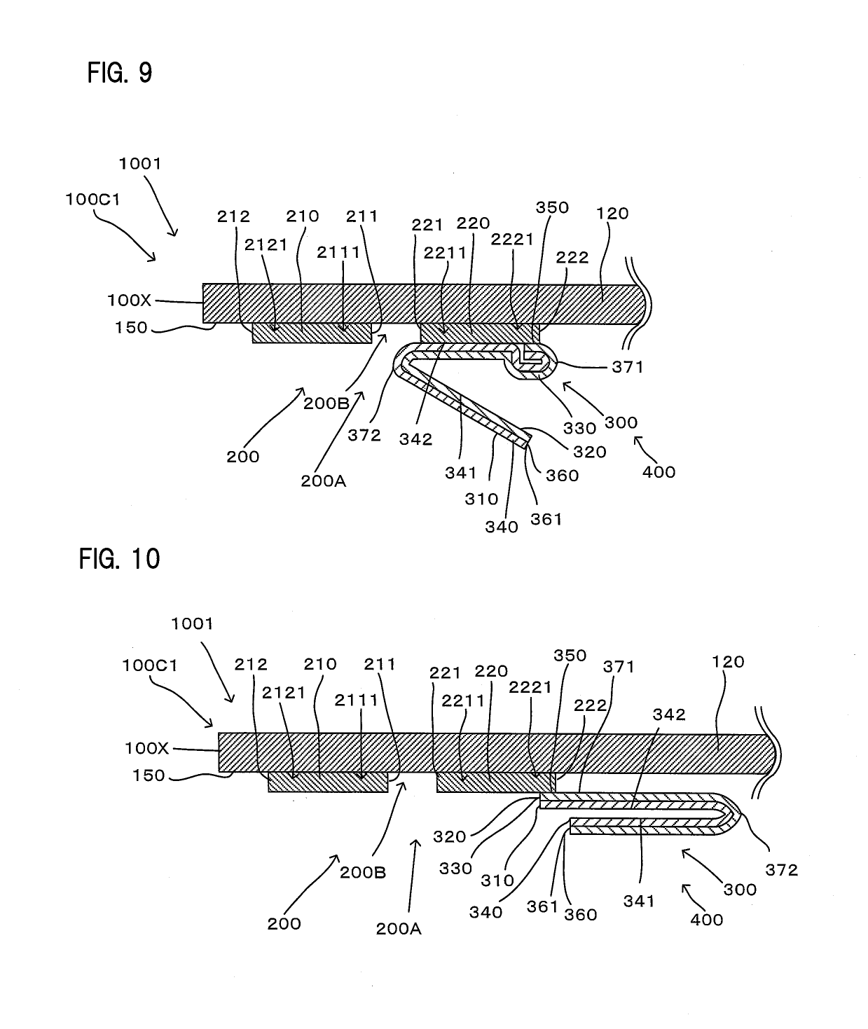

The release sheet 300 has a fold formed along the release sheet middle folding part 372. As shown in FIG. 9, when the first inhibiting region 341 is removed from the first adhesion region 210, the removal starting end 361 is located on the second adhesion region 220 side. Thus, the first inhibiting region 341 does not easily get into contact with the first adhesion region 210.

When the user desires to attach only the first adhesion region 210 to the placing object, as shown in FIG. 9, the first inhibiting region 341 is removed from the first adhesion region 210. In this state, the pet absorbent sheet 1001 can be attached to the placing object by the first adhesion region 210.

When the user further desires to attach the pet absorbent sheet 1001 more securely to the placing object, as shown in FIG. 10, the second inhibiting region 342 is also removed from the second adhesion region 220. In this state, both the first adhesion region 210 and the second adhesion region 220 are exposed on the placing surface 150 of the pet absorbent sheet 1001. Thus, the user can attach the first and second adhesion regions 210, 220 of the pet absorbent sheet 1001 to the placing object.

Even when the first inhibiting region 341 and the second inhibiting region 342 of the release sheet 300 are removed from the adhesion region 200, the fixed region 362A on the second release sheet surface 320 of the release sheet 300 is kept fixed to the second adhesion region 220. Therefore, the release sheet 300 is never completely removed from the pet absorbent sheet 1001. Thus, the user does not have to have a trouble of disposing of the release sheet 300, so that the user-friendliness of the pet absorbent sheet 1001 can be improved.

As described above, the release sheet 300 of the pet absorbent sheet 1001 according to the first embodiment pattern is configured to form the guiding part 400 such that the first inhibiting region 341 is first removed from the first adhesion region 210 and then the second inhibiting region 342 is removed from the second adhesion region 220. Therefore, the pet absorbent sheet 1001 according to the first embodiment pattern can achieve the effect of the above-described pet absorbent sheet 100 having the general basic structure.

### Second Embodiment Pattern

Referring to FIGS. 11 to 14, a pet absorbent sheet 1002 according to the second embodiment pattern is explained. FIG. 11 is an enlarged sectional view showing the adhesion region 200 just after the pet absorbent sheet 1002 is taken out of a package by a user. The pet absorbent sheet 1002 is left folded along the entire folding line 160.

In the release sheet 300 on the pet absorbent sheet 1002, the promoting region 350 is provided in a region of the first release sheet surface 310 on the second inhibiting region 342 side. The promoting region 350 is attached to the farther end region 2221 of the second adhesion region 220.

When using the pet absorbent sheet 1002, as shown in FIG. 12, the pet absorbent sheet 1002 is unfolded along the entire folding line 160.

Then the user holds the removal starting end 361 and removes the first inhibiting region 341 of the release sheet 300 from the first adhesion region 210. In such removal of the first inhibiting region 341 from the first adhesion region 210, the user can also hold the removal starting region 361A.

The release sheet 300 has a fold formed along the release sheet middle folding part 372. As shown in FIG. 13, when the first inhibiting region 341 is removed from the first adhesion region 210, the removal starting end 361 is located on the second adhesion region 220 side. Thus, the first inhibiting region 341 does not easily get into contact with the first adhesion region 210.

When the user desires to attach only the first adhesion region 210 to the placing object, as shown in FIG. 13, the first inhibiting region 341 is removed from the first adhesion region 210. In this state, the pet absorbent sheet 1002 can be attached to the placing object by the first adhesion region 210.

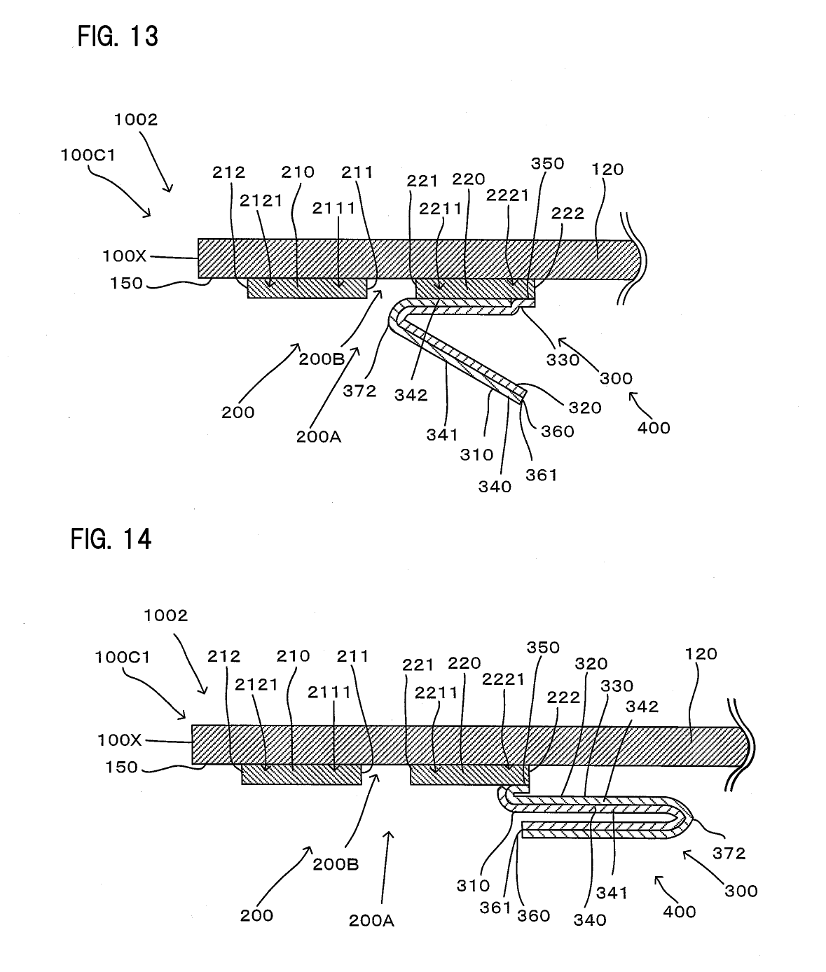

When the user further desires to attach the pet absorbent sheet 1002 more securely to the placing object, as shown in FIG. 14, the second inhibiting region 342 of the release sheet 300 is also removed from the second adhesion region 220. In this state, both the first adhesion region 210 and the second adhesion region 220 are exposed on the placing surface 150 of the pet absorbent sheet 1002. Thus, the user can attach the first and second adhesion regions 210, 220 of the pet absorbent sheet 1002 to the placing object.

Even when the first inhibiting region 341 and the second inhibiting region 342 of the release sheet 300 are removed from the adhesion region 200, the fixed region 362A on the first release sheet surface 310 of the release sheet 300 is kept fixed to the second adhesion region 220. Therefore, the release sheet 300 is never completely removed from the pet absorbent sheet 1002. Thus, the user does not have to have a trouble of disposing of the release sheet 300, so that the user-friendliness of the pet absorbent sheet 1002 can be improved.

As described above, the release sheet 300 of the pet absorbent sheet 1002 according to the second embodiment pattern is configured to form the guiding part 400 such that the first inhibiting region 341 is first removed from the first adhesion region 210 and then the second inhibiting region 342 is removed from the second adhesion region 220. Therefore, the pet absorbent sheet 1002 according to the second embodiment pattern can achieve the effect of the above-described pet absorbent sheet 100 having the general basic structure.

In the above-described first and second embodiment patterns, the fixed region 362A is described as being formed in the second adhesion region 220. The fixed region 362A may however be formed on the placing surface 150 by providing such that the release sheet 300 extends onto the placing surface 150. Such a pet absorbent sheet has the same effect as the first and second embodiment patterns in that the release sheet 300 does not fall off the pet absorbent sheet even after the second adhesion region 220 is exposed.

It may also be configured without providing the promoting region 350 on the release sheet 300. In such a case, the release sheet 300 falls off the pet absorbent sheet after the second adhesion region 220 is exposed. Therefore, such a structure does not have the effect of the first and second embodiment patterns that the release sheet 300 does not fall off the pet absorbent sheet, but it can achieve the other effects of the first and second embodiment patterns.

### Second Basic Structure

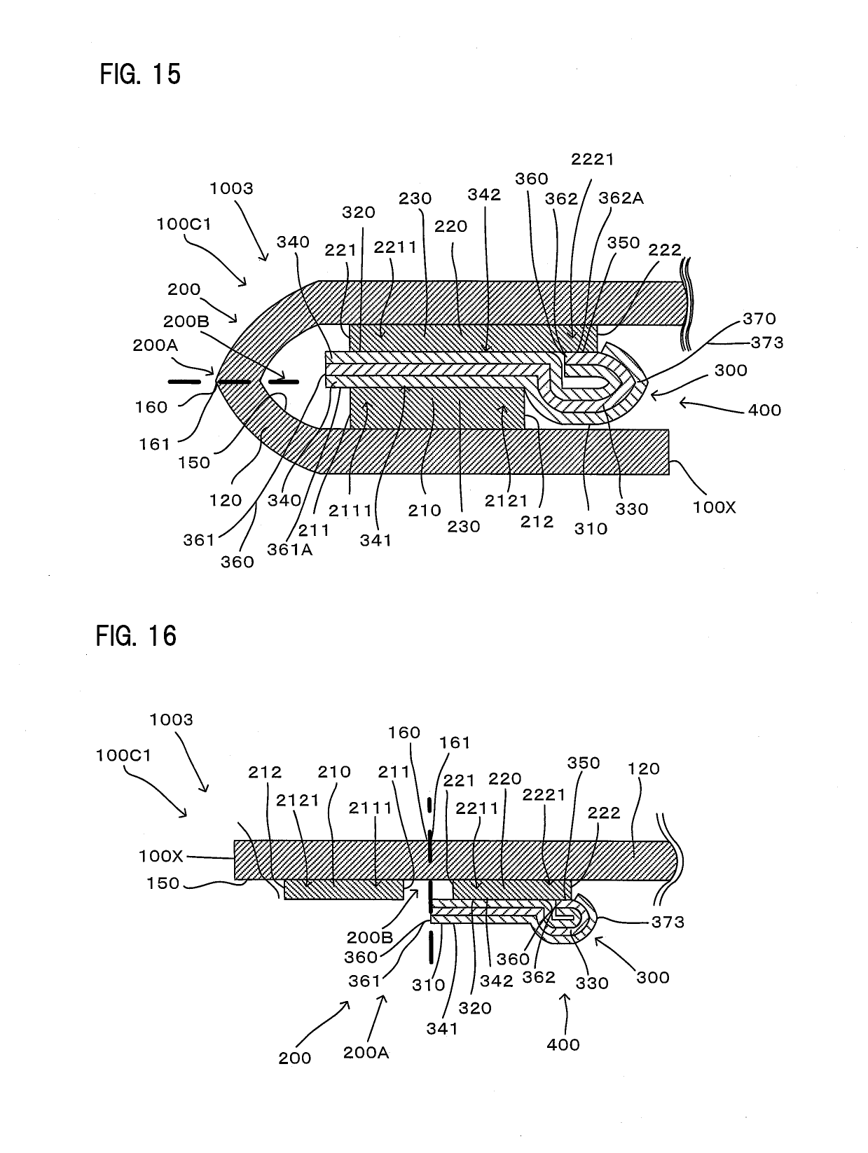

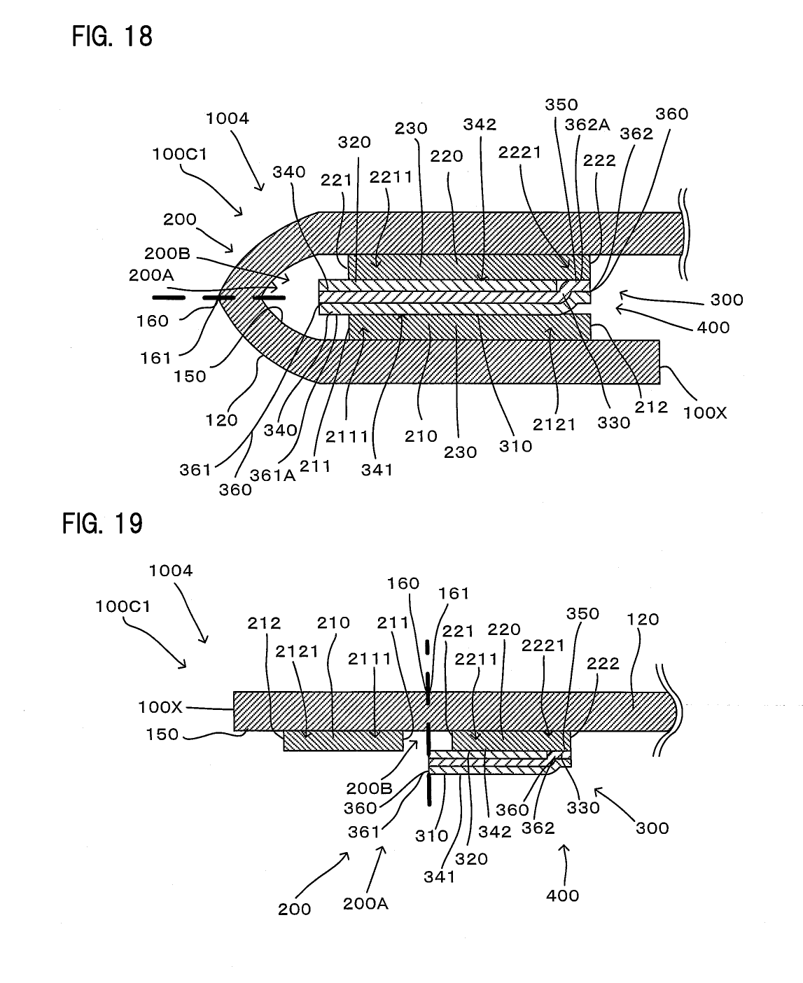

Referring to FIGS. 15 to 20, a second basic structure is explained. The specific structure of the second basic structure is described based on the third and fourth embodiment patterns. FIGS. 15 to 17 are explanatory drawings illustrating the third embodiment pattern, and FIGS. 18 to 20 are explanatory drawings illustrating the fourth embodiment pattern.

First, features of the second basic structure common to the third and fourth embodiment patterns are explained.

In the second basic structure, the release sheet 300 which forms the guiding part 400 is provided to have an area enough to cover a larger one of the first adhesion region 210 and the second adhesion region 220. The release sheet 300 has the inhibiting region 340 on the both sides. Specifically, a first inhibiting region 341 which is attached to the first adhesion region 210 is formed on the first release sheet surface 310 of the release sheet 300, while a second inhibiting region 342 which is attached to the second adhesion region 220 is formed on the second release sheet surface 320.

The release sheet 300 further has the promoting region 350. The promoting region 350 is formed in a region of the release sheet 300 which is attached to the second adhesion region 220.

The release sheet 300 further has a region extending beyond the adjacent end 221 of the second adhesion region 220.

In the pet absorbent sheet according to the second basic structure, like the pet absorbent sheet according to the above-described first basic structure, the release sheet 300 also has the fixed end 362, the removal starting end 361, the fixed region 362A and the removal starting region 361A.

In the pet absorbent sheet according to the second basic structure, adhesives 230 having different composition are applied to the first adhesion region 210 and the second adhesion region 220. Specifically, the adhesives 230 are selected such that one for the second adhesion region 220 has a stronger adhesive force than the other for the first adhesion region 210.

In manufacturing the pet absorbent sheet according to the second basic structure, first, the pet absorbent sheet is spread out flat and the promoting region 350 of the release sheet 300 is fixed to the second adhesion region 220. At this time, the second inhibiting region 342 of the release sheet 300 adheres to the second adhesion region 220.

Subsequently, the pet absorbent sheet is folded back along the entire folding line 160. As a result, the first adhesion region 210 adheres to the first inhibiting region 341 of the release sheet 300.

### Third Embodiment Pattern

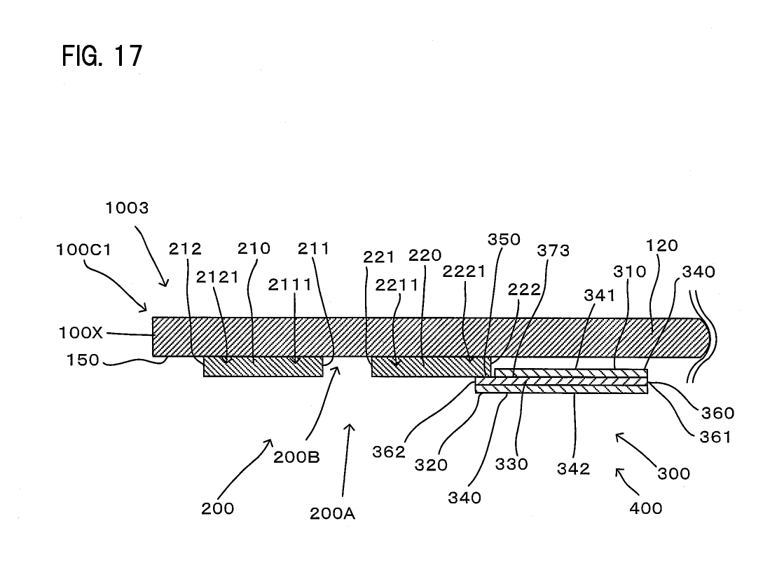

Referring to FIGS. 15 to 17, a pet absorbent sheet 1003 according to the third embodiment pattern is explained. In FIG. 15, compared with the other drawings (FIGS. 16 and 17) for illustrating the third embodiment pattern, the first adhesion region 210 is shown deformed for the sake of explanation. FIG. 15 is an enlarged sectional view showing the adhesion region 200 just after the pet absorbent sheet 1003 is taken out of a package by a user. The pet absorbent sheet 1003 is left folded along the entire folding line 160.

In the release sheet 300 of the pet absorbent sheet 1003, the promoting region 350 is formed on the first release sheet surface 310. The promoting region 350 is attached to the farther end region 2221 of the second adhesion region 220.

The release sheet 330 is folded back along a second release sheet folding part 373. The second release sheet folding part 373 is formed near the farther end 222 of the second adhesion region 220 in the release sheet 300 and outside the fixed region 362A. Thus, the first release sheet surface 310 of the release sheet 300 faces the first adhesion region 210.

As described above, by folding back the pet absorbent sheet 1003 along the entire folding line 160, the first adhesion region 210 adheres to the first inhibiting region 341 of the release sheet 300, and the second adhesion region 220 adheres to the second inhibiting region 342 of the release sheet 300.

When using the pet absorbent sheet 1003, as shown in FIG. 16, the pet absorbent sheet 1003 is unfolded along the entire folding line 160.

At this time, the first inhibiting region 341 of the release sheet 300 is removed from the first adhesion region 210 since the second adhesion region 220 has a stronger adhesive force than the first adhesion region 210. Thus, the user can expose the first adhesion region 210 by the operation of unfolding the pet absorbent sheet 1003 folded along the pet sheet folding part 161.

When the user desires to attach only the first adhesion region 210 to the placing object, as shown in FIG. 16, the first inhibiting region 341 is removed from the first adhesion region 210. In this state, the pet absorbent sheet 1003 can be attached to the placing object by the first adhesion region 210.

When the user further desires to attach the pet absorbent sheet 1003 more securely to the placing object, as shown in FIG. 17, the second inhibiting region 342 of the release sheet 300 is also removed from the second adhesion region 220. In this state, both the first adhesion region 210 and the second adhesion region 220 are exposed on the placing surface 150 of the pet absorbent sheet 1003. Thus, the user can attach the first and second adhesion regions 210, 220 of the pet absorbent sheet 1003 to the placing object.

Even when the first inhibiting region 341 and the second inhibiting region 342 of the release sheet 300 are removed from the adhesion region 200, the fixed region 362A on the first release sheet surface 310 of the release sheet 300 is kept fixed to the second adhesion region 220. Therefore, the release sheet 300 is never completely removed from the pet absorbent sheet 1003. Thus, the user does not have to have a trouble of disposing of the release sheet 300, so that the user-friendliness of the pet absorbent sheet 1003 can be improved.

As described above, the release sheet 300 of the pet absorbent sheet 1003 according to the third embodiment pattern is configured to form the guiding part 400 such that the first inhibiting region 341 is first removed from the first adhesion region 210 and then the second inhibiting region 342 is removed from the second adhesion region 220. Therefore, the pet absorbent sheet 1003 according to the third embodiment pattern can achieve the effect of the above-described pet absorbent sheet 100 having the general basic structure.

### Fourth Embodiment Pattern

Referring to FIGS. 18 to 20, a pet absorbent sheet 1004 according to the fourth embodiment pattern is explained. FIG. 18 is an enlarged sectional view showing the adhesion region 200 just after the pet absorbent sheet 1004 is taken out of a package by a user. The pet absorbent sheet 1004 is left folded along the entire folding line 160.

In the release sheet 300 of the pet absorbent sheet 1004, the promoting region 350 is formed on the second release sheet surface 320. The promoting region 350 is attached to the farther end region 2221 of the second adhesion region 220.

As described above, by folding back the pet absorbent sheet 1004 along the entire folding line 160, the first adhesion region 210 adheres to the first inhibiting region 341 of the release sheet 300, and the second adhesion region 220 adheres to the second inhibiting region 342 of the release sheet 300.

When using the pet absorbent sheet 1004, as shown in FIG. 18, the pet absorbent sheet 1004 is unfolded along the pet sheet folding part 161.

At this time, the first inhibiting region 341 of the release sheet 300 is removed from the first adhesion region 210 since the second adhesion region 220 has a stronger adhesive force than the first adhesion region 210. Thus, the user can expose the first adhesion region 210 by the operation of unfolding the pet absorbent sheet 1004 folded along the pet sheet folding part 161.

When the user desires to attach only the first adhesion region 210 to the placing object, as shown in FIG. 19, the first inhibiting region 341 is removed from the first adhesion region 210. In this state, the pet absorbent sheet 1004 can be attached to the placing object by the first adhesion region 210.

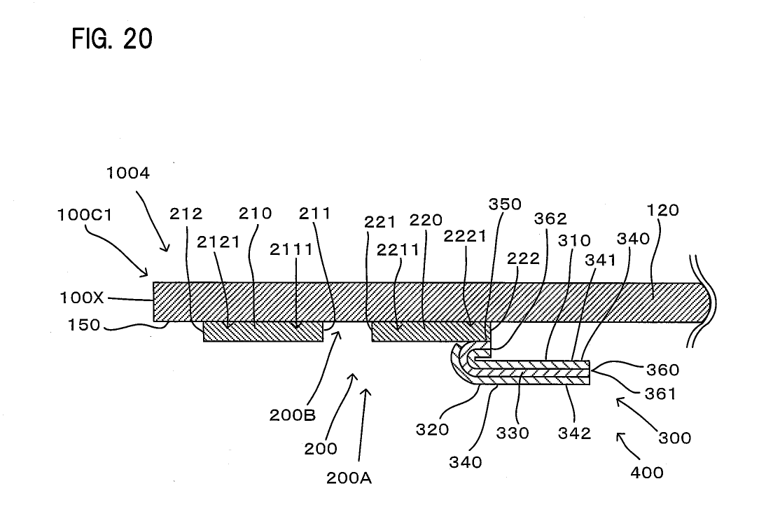

When the user further desires to attach the pet absorbent sheet 1004 more securely to the placing object, as shown in FIG. 20, the second inhibiting region 342 of the release sheet 300 is also removed from the second adhesion region 220. In this state, both the first adhesion region 210 and the second adhesion region 220 are exposed on the placing surface 150 of the pet absorbent sheet 1004. Thus, the user can attach the first and second adhesion regions 210, 220 of the pet absorbent sheet 1004 to the placing object.

Even when the first inhibiting region 341 and the second inhibiting region 342 of the release sheet 300 are removed from the adhesion region 200, the fixed region 362A on the second release sheet surface 320 of the release sheet 300 is kept fixed to the second adhesion region 220. Therefore, the release sheet 300 is never completely removed from the pet absorbent sheet 1004. Thus, the user does not have to have a trouble of disposing of the release sheet 300, so that the user-friendliness of the pet absorbent sheet 1004 can be improved.

As described above, the release sheet 300 of the pet absorbent sheet 1004 according to the fourth embodiment pattern is configured to form the guiding part 400 such that the first inhibiting region 341 is first removed from the first adhesion region 210 and then the second inhibiting region 342 is removed from the second adhesion region 220. Therefore, the pet absorbent sheet 1004 according to the fourth embodiment pattern can achieve the effect of the above-described pet absorbent sheet 100 having the general basic structure.

In the above-described third and fourth embodiment patterns, the fixed region 362A is described as being formed in the second adhesion region 220. The fixed region 362A may however be formed on the placing surface 150 by providing the release sheet 300 which extends onto the placing surface 150. Such a pet absorbent sheet has the same effect as the third and fourth embodiment patterns in that the release sheet 300 does not fall off the pet absorbent sheet even after the second adhesion region 220 is exposed.

It may also be configured without providing the promoting region 350 on the release sheet 300. In such a case, the release sheet 300 falls off the pet absorbent sheet after the second adhesion region 220 is exposed. Therefore, such a structure does not have the effect of the third and fourth embodiment patterns that the release sheet 300 does not fall off the pet absorbent sheet, but it can achieve the other effects of the third and fourth embodiment patterns.

### Third Basic Structure

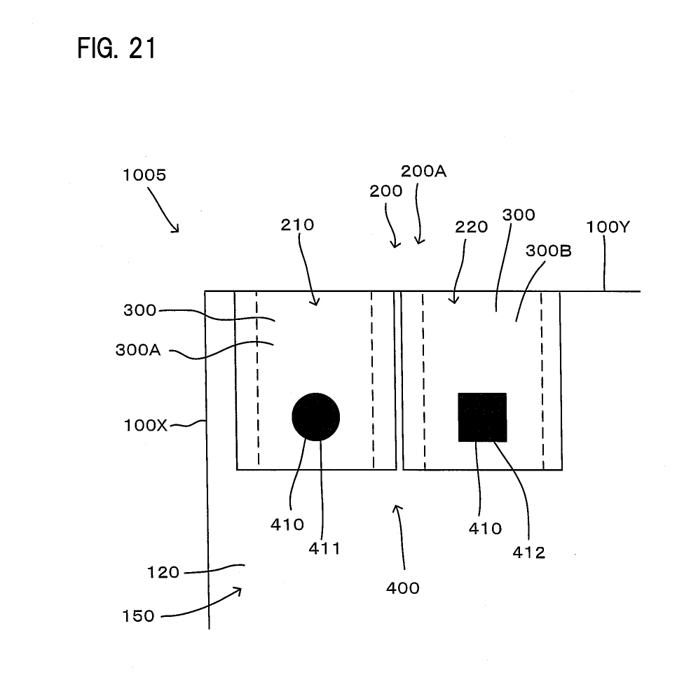

Referring to FIGS. 21 to 24, a third basic structure is explained. The specific structure of the third basic structure is described based on the fifth embodiment pattern.

In the third basic structure, the release sheet 300 which forms the guiding part 400 has a display part 410. The display part 410 is formed on the side opposite to the inhibiting region 340. Specifically, in the release sheet 300, when the inhibiting region 340 is formed on the first release sheet surface 310, the display part 410 is formed on the second release sheet surface 320. The display part 410 includes a first display part 411 formed on the side of the release sheet 300 opposite to the first inhibiting region 341, and a second display part 412 formed on the side of the release sheet 300 opposite to the second inhibiting region 342.

The first display part 411 indicates that the release sheet 300 having the first display part 411 is attached to the first adhesion region 210, and the second display part 412 indicates that the release sheet 300 having the second display part 412 is attached to the second adhesion region 220. This indication may be provided by using letters, words, characters or symbols either alone or in combination. This indication indicates that the release sheet 300 having the first display part 411 is removed first and then the release sheet 300 having the second display part 412 is removed. Specifically, such an indication can be provided, for example, by a display “Removing Order 1st” on the first display part 411 and a display “Removing Order 2nd” on the second display part 412.

By thus providing the display part 410, the guiding part 400 is configured such that the first adhesion region 210 is exposed first and the second adhesion region 220 is exposed next.

### Fifth Embodiment Pattern

Referring to FIGS. 21 to 24, a pet absorbent sheet 1005 according to the fifth embodiment pattern is explained. The pet absorbent sheet 1005 is left folded along the pet sheet folding part 161 just after the pet absorbent sheet 1005 is taken out of a package. In FIG. 21, the pet absorbent sheet 1005 folded along the pet sheet folding part 161 is shown unfolded flat.

The release sheet 300 has a first release sheet 300A which is attached to the first adhesion region 210, and a second release sheet 300B which is attached to the second adhesion region 220. The first release sheet 300A has the first inhibiting region 341 on the first release sheet surface 310 and the first display part 411 on the second release sheet surface 320. The second release sheet 300B has the second inhibiting region 342 on the first release sheet surface 310 and the second display part 412 on the second release sheet surface 320.

When using the pet absorbent sheet 1005, as shown in FIG. 22, the pet absorbent sheet 1005 is unfolded along the pet sheet folding part 161.

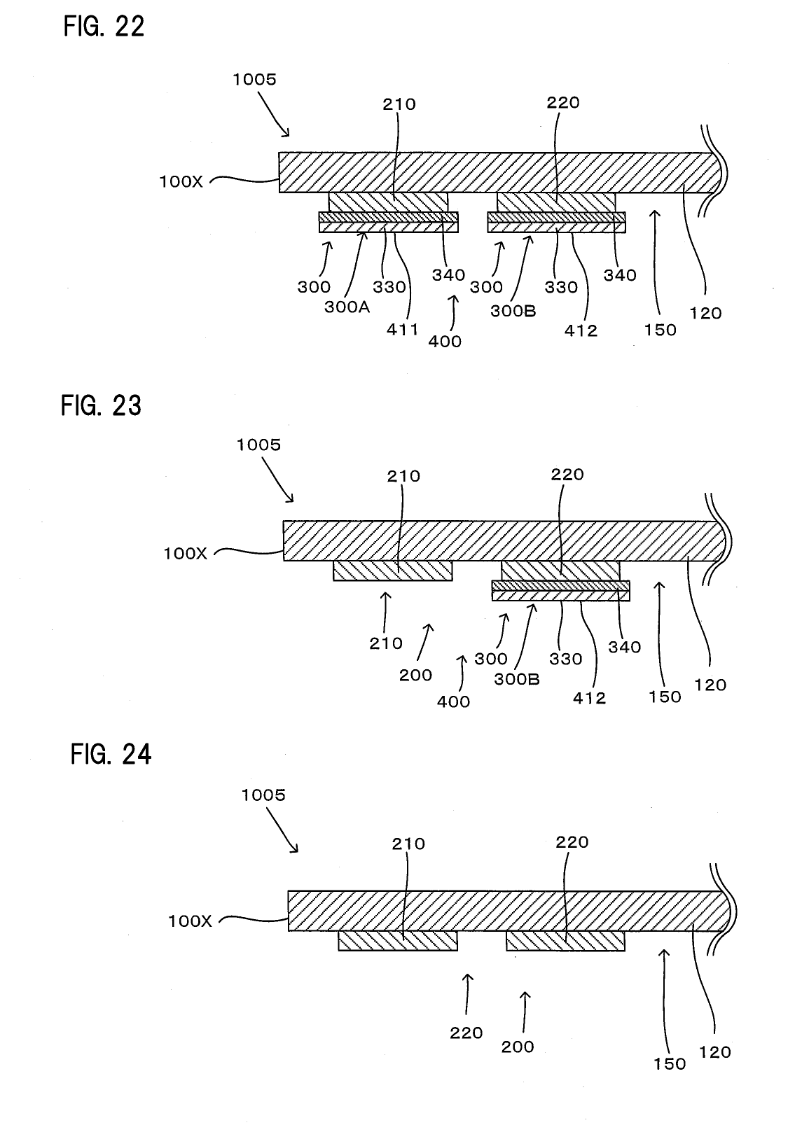

Subsequently, as shown in FIG. 23, the first release sheet 300A is removed from the first adhesion region 210 according to the indication of the first display part 411. As a result, the first adhesion region 210 is exposed.

When the user desires to attach only the first adhesion region 210 to the placing object, as shown in FIG. 23, the first inhibiting region 341 is removed from the first adhesion region 210. In this state, the pet absorbent sheet 1005 can be attached to the placing object by the first adhesion region 210.

When the user further desires to attach the pet absorbent sheet 1005 more securely to the placing object, as shown in FIG. 24, the second release sheet 300B is also removed from the second adhesion region 220 according to the indication of the second display part 412. As a result, the second adhesion region 220 is exposed.

In this state, both the first adhesion region 210 and the second adhesion region 220 are exposed on the placing surface 150 of the pet absorbent sheet 1005. Thus, the user can attach the first and second adhesion regions 210, 220 of the pet absorbent sheet 1005 to the placing object.

As described above, the release sheet 300 of the pet absorbent sheet 1005 according to the fifth embodiment pattern is configured to form the guiding part 400 such that the first inhibiting region 341 is first removed from the first adhesion region 210 and then the second inhibiting region 342 is removed from the second adhesion region 220. Therefore, the pet absorbent sheet 1005 according to the fifth embodiment pattern can achieve the effect of the above-described pet absorbent sheet 100 having the general basic structure.

In the fifth embodiment pattern, the display part 410 is described as having the first display part 411 and the second display part 412, but it may have a single structure. In such a case, if the display part 410 is provided on the first release sheet 300A, for example, the display part 410 may have an indication by words such as “Remove this release sheet first”. If the display part 410 is provided on the second release sheet 300B, for example, the display part 410 may have an indication by words such as “Remove this release sheet after the first release sheet 300A”.

### Fourth Basic Structure and Sixth Embodiment Pattern

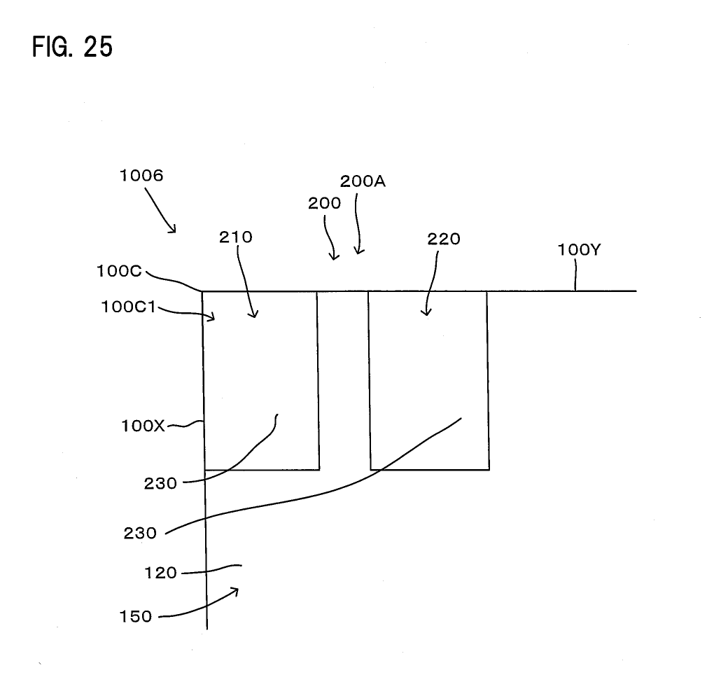

Referring to FIG. 25, a structure according to the fourth embodiment pattern is explained. The specific structure of the fourth basic structure is described based on the sixth embodiment pattern.

The fourth basic structure is related to arrangement of the adhesion region 200.

The above-described pet absorbent sheet 100 having the basic structure is described as being provided such that an end of the adhesion region 200 in the longitudinal direction Y coincides with the longitudinal end 100Y of the pet absorbent sheet 100, but arrangement of the adhesion region 200 on the pet absorbent sheet is not limited to this.

FIG. 25 shows a pet absorbent sheet 1006 according to the sixth embodiment pattern.

In the pet absorbent sheet 1006, an end of the adhesion region 200 in the longitudinal direction Y and an end of the adhesion region 200 in the lateral direction X coincide with the longitudinal end 100Y and the lateral end 100X of the pet absorbent sheet 1006, respectively. In this case, the adhesion region 200 is formed on the corner 100C of the pet absorbent sheet 1006.

In such a structure, compared with the pet absorbent sheet 100 having the basic structure, an area not having the adhesion region 200 can be reduced in a region including the ends 100Y, 100X of the pet absorbent sheet 1006. This makes more difficult for a pet to try to remove the pet absorbent sheet 1006.

Further, it may also be configured such that only the end of the adhesion region 200 in the lateral direction X and the lateral end 100X of the pet absorbent sheet coincide with each other.

### Fifth Basic Structure

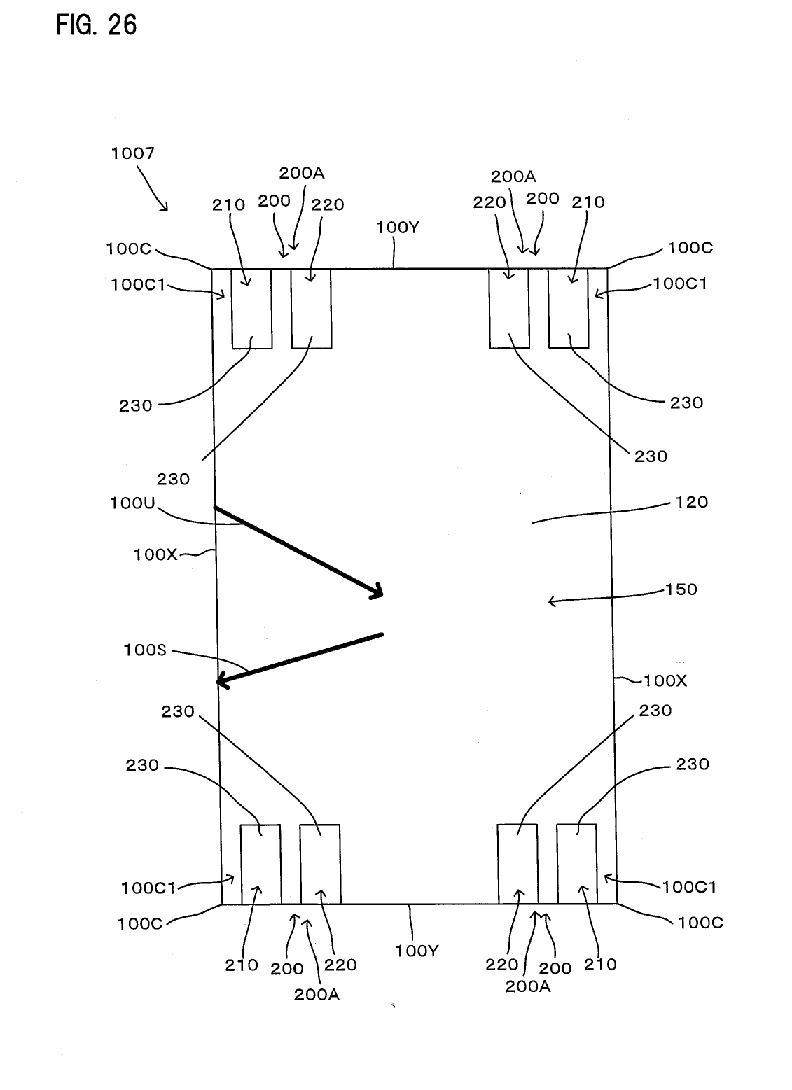

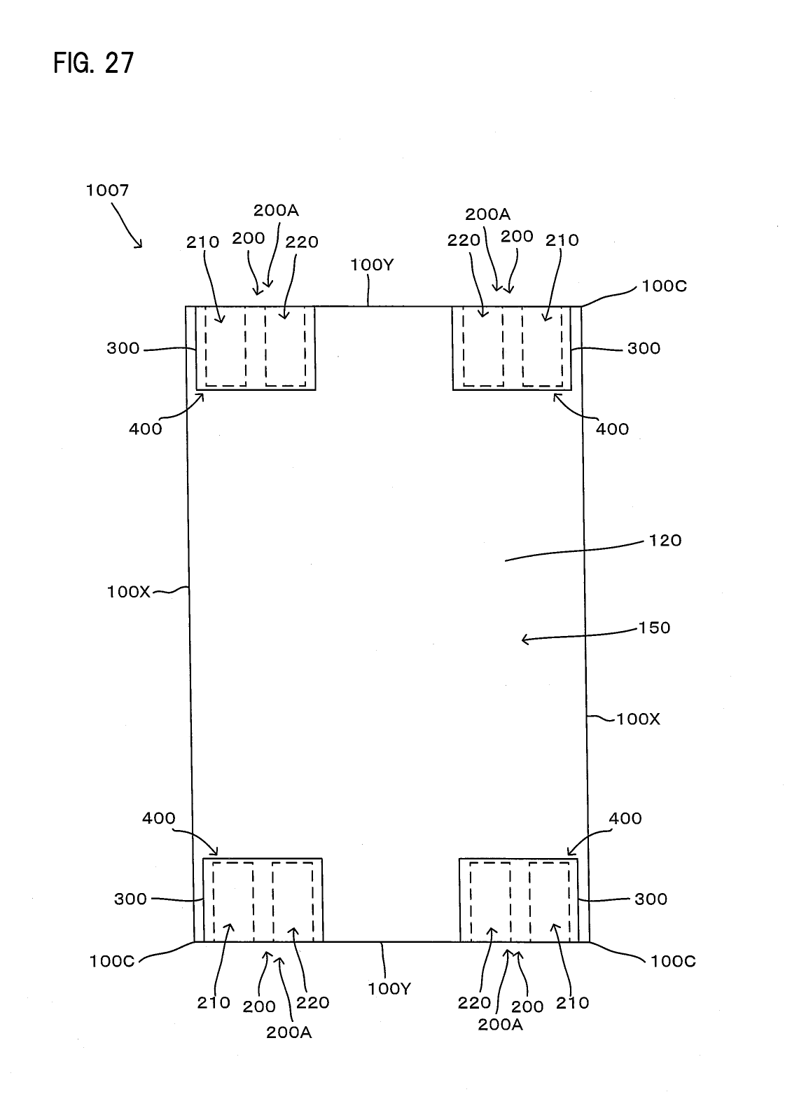

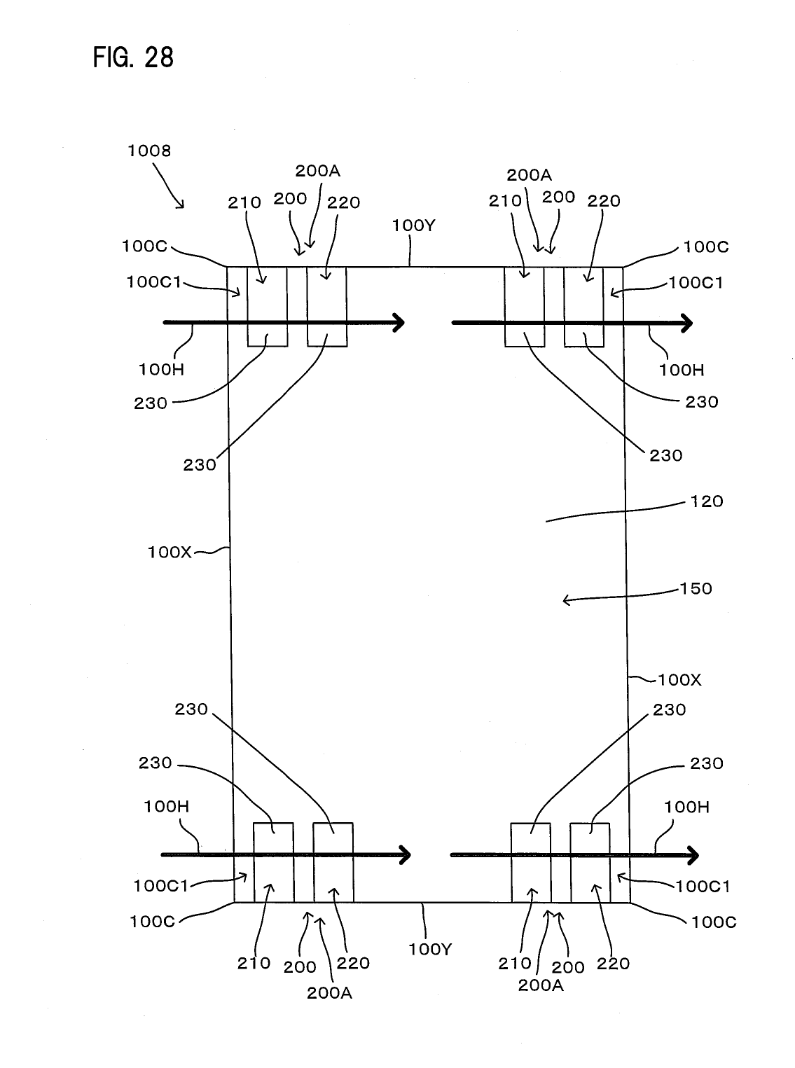

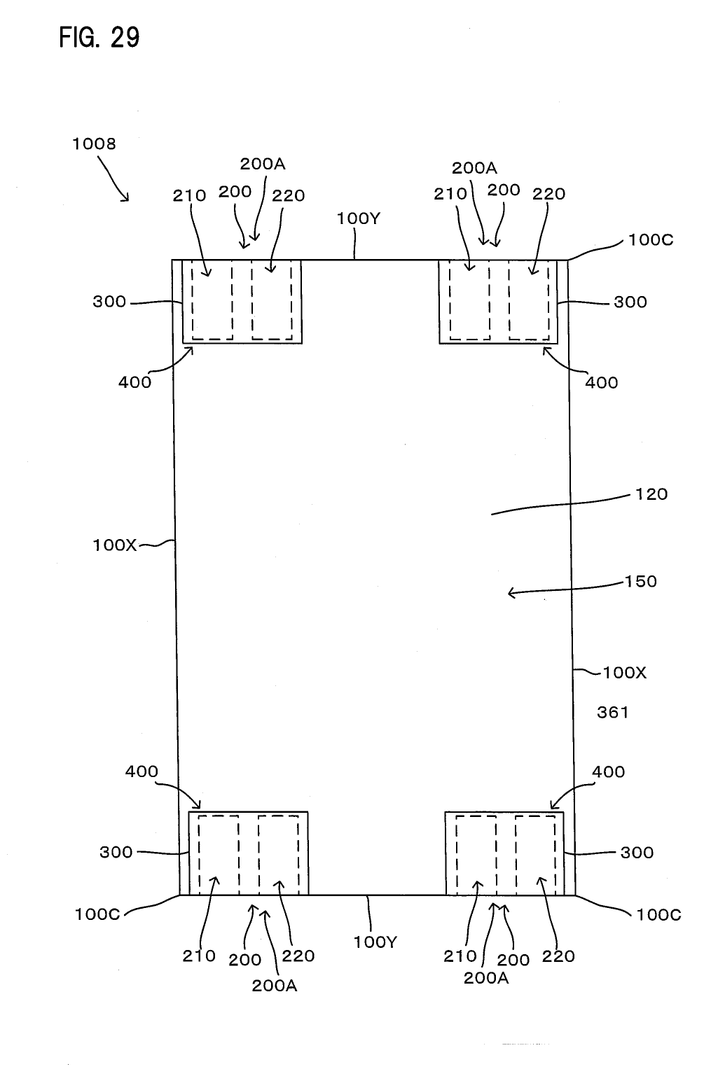

Referring to FIGS. 26 to 29, a structure according to the fifth embodiment pattern is explained. The specific structure of the fifth basic structure is described based on the seventh and eighth embodiment patterns. FIGS. 26 and 27 are explanatory drawings of the seventh embodiment pattern, and FIGS. 28 and 29 are explanatory drawings of the eighth embodiment pattern. The seventh and eighth embodiment patterns are related to arrangement of the first and second adhesion regions 210, 220 in the adjacent adhesion region 200A.

### Seventh Embodiment Pattern

Referring to FIGS. 26 and 27, a pet absorbent sheet 1007 according to the seventh embodiment pattern is explained.

In the pet absorbent sheet 1007, an inward direction 100U from an end region (not shown) toward a central region (not shown) and an outward direction 100S from the central region toward the end region are defined. The end region refers to a region including the longitudinal end 100Y or the lateral end 100X in the pet absorbent sheet. The central region refers to a region including a center in the longitudinal direction Y and the lateral direction X and not including the end region in the pet absorbent sheet.

The pet absorbent sheet 1007 has a plurality of adjacent adhesion regions 200A. The pet absorbent sheet 1007 shown in FIGS. 26 and 27 has four adjacent adhesion regions 200A, but it is necessary to provide just a plurality of adjacent adhesion regions 200A. The number of the adjacent adhesion regions 200A can be arbitrarily chosen according to the pet absorbent sheet to be realized.

In the pet absorbent sheet 1007 according to the seventh embodiment pattern, the first adhesion region 210 is arranged in an outward region in the outward direction 100S in a plurality of the adjacent adhesion regions 200A. In the pet absorbent sheet 1007 shown in the drawings, the first adhesion region 210 is arranged in the outward region in the outward direction 100S in each of the four adjacent adhesion regions 200A.

In the pet absorbent sheet 1007 according to the seventh embodiment pattern, the adhesives 230 are applied to both of the first and second adhesion regions 210, 220. The adhesive 230 of the second adhesion region 220 has a stronger adhesive force than the adhesive 230 of the first adhesion region 210.

In the pet absorbent sheet 1007, the first adhesion region 210 having a weaker adhesive force is arranged in the outward region in the outward direction 100S. In this case, it is advantageous and preferable that the end region of the pet absorbent sheet 1007 is attached to a placing object in order to prevent the pet absorbent sheet 1007 from being turned up. For this purpose, it is preferable to expose the first adhesion region 210 prior to the second adhesion region 220.

FIG. 27 shows the pet absorbent sheet 1007 with the release sheet 300 attached to the adhesion region 200. The above-described guiding part 400 is appropriately selected as the release sheet 300 of the pet absorbent sheet 1007. By provision of the guiding part 400, the user can reliably expose both of the first and second adhesion regions 210, 220 and attach them to the placing object.

### Eighth Embodiment Pattern

Referring to FIGS. 28 and 29, a pet absorbent sheet 1008 according to the eighth embodiment pattern is explained.

In the pet absorbent sheet 1008 of the eighth embodiment pattern, the first adhesion region 210 and the second adhesion region 220 are arranged in the same order in an arrangement direction 100H in a plurality of the adjacent adhesion regions 200A. In the pet absorbent sheet 1008 shown in the drawings, the first adhesion region 210 and the second adhesion region 220 are arranged in the same order in the arrangement direction 100H in each of the four adjacent adhesion regions 200A.

FIG. 28 shows the pet absorbent sheet 1008 with the release sheet 300 attached to the adhesion region 200. The above-described guiding part 400 is appropriately selected as the release sheet 300 of the pet absorbent sheet 1008.

In using the above-described pet absorbent sheet 1008, the user exposes the first adhesion region 210 and attaches it to a placing object in the following manner. The user removes the release sheet 300 from the first adhesion region 210 from left to right as viewed in FIG. 29. The direction of removing the release sheet 300 to expose the first adhesion region 210 is the same in the entire adhesion region 200.

Specifically, when removing the release sheet 300 from the first adhesion region 210, the user holds the end of the release sheet 300 and turns or moves the wrist. The operations of turning or moving the user's wrist in order to remove the release sheet 300 are performed in the same direction in the entire adhesion region 200 of the pet absorbent sheet 1008. Therefore, the pet absorbent sheet 1008 of the eighth embodiment pattern can be provided with improved user-friendliness.

The structures of the pet absorbent sheets according to the present invention are not limited to those as described above. The basic structure and the features of the first to eighth embodiment patterns can be applied in appropriate combinations.

### Correspondences Between the Features of the Embodiment and the Features of the Invention

The pet absorbent sheets 100, 1001, 1002, 1003, 1004, 1005, 1006, 1007, 1008 are features that correspond to the “pet absorbent sheet” according to this invention. The top sheet 110, the back sheet 120 and the absorbing core 130 are features that correspond to the “first sheet”, the “second sheet” and the “absorbing core”, respectively, according to this invention. The excretion surface 140 and the placing surface 150 are features that correspond to the “excretion surface” and the “placing surface”, respectively, according to this invention. The adhesion region 200, the first adhesion region 210 and the second adhesion region 220 are features that correspond to the “adhesion region”, the “first adhesion region” and the “second adhesion region”, respectively, according to this invention. The adhesive 230 and the adhesive region 231 are features that correspond to the “adhesive” and the “adhesive region”, respectively, according to this invention. The release sheet 300, the first release sheet surface 310 and the second release sheet surface 320 are features that correspond to the “release sheet”, the “one side”, and the “other side”, respectively, according to this invention. The inhibiting region 340 and the promoting region 350 are features that correspond to the “inhibiting region” and the “promoting region”, respectively, according to this invention. The guiding part 400 is a feature that corresponds to the “guiding part” according to this invention. The pet sheet folding part 161 is a feature that corresponds to the “pet sheet folding part” according to this invention. The release sheet middle folding part 372 is a feature that corresponds to the “release sheet middle folding part” according to this invention.

In view of the above-described nature of the present invention, the following various provisions can be made.

(1)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order, and

adhesive force in the first adhesion region is rendered weaker than adhesive force in the second adhesion region, whereby the first adhesion region is formed in a different manner from the second adhesion region.

(2)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region, and

the adhesion region comprises an adhesive region having an adhesive applied thereto.

(3)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region,

the adhesion region comprises an adhesive region having an adhesive applied thereto, and

the guiding part is configured such that the first adhesion region is exposed first and the second adhesion region is exposed next.

(4)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region,

the adhesion region comprises an adhesive region having an adhesive applied thereto,

the guiding part is configured such that the first adhesion region is exposed first and the second adhesion region is exposed next, and

the guiding part has a release sheet arranged on at least part of the adhesion region, and the release sheet has one side and the other side opposite to the one side.

(5)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region,

the adhesion region comprises an adhesive region having an adhesive applied thereto,

the guiding part is configured such that the first adhesion region is exposed first and the second adhesion region is exposed next,

the guiding part has a release sheet arranged on at least part of the adhesion region, and the release sheet has one side and the other side opposite to the one side,

the release sheet has an inhibiting region for inhibiting adhesion to the adhesion region, and

the release sheet has a promoting region for promoting adhesion to the adhesion region.

(6)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region,

the adhesion region comprises an adhesive region having an adhesive applied thereto,

the guiding part is configured such that the first adhesion region is exposed first and the second adhesion region is exposed next,

the guiding part has a release sheet arranged on at least part of the adhesion region, and the release sheet has one side and the other side opposite to the one side,

the release sheet has an inhibiting region for inhibiting adhesion to the adhesion region,

the release sheet has a promoting region for promoting adhesion to the adhesion region,

the release sheet has the inhibiting region on the one side,

in the release sheet attached to the adhesion region, the inhibiting region has a first inhibiting region which is removably attached to the first adhesion region, and a second inhibiting region which is removably attached to the second adhesion region, and

the guiding part is configured such that the first inhibiting region is first removed from the first adhesion region and then the second inhibiting region is removed from the second adhesion region.

(7)

The pet absorbent sheet as defined in (6), wherein:

the release sheet has the promoting region in a region of the other side on the second inhibiting region side and a removal starting end formed in a region of the other side on the first inhibiting region side,

the promoting region is attached to a region on the second adhesion region which is separated from the first adhesion region in a positional relation between the first adhesion region and the second adhesion region in the pet absorbent sheet ready to be attached to the placing object, and

the release sheet is folded back along a first release sheet folding part, whereby the one side faces the adhesion region.

(8)

The pet absorbent sheet as defined in (6), wherein:

the release sheet has the promoting region in a region of the one side on the second inhibiting region side and a removal starting end formed in a region of the one side on the first inhibiting region side, and

the promoting region is attached to a region on the second adhesion region which is separated from the first adhesion region in a positional relation between the first adhesion region and the second adhesion region in the pet absorbent sheet ready to be attached to the placing object.

(9)

A pet absorbent sheet, comprising:

a liquid-permeable first sheet,

a liquid-impermeable second sheet,

an absorbing core disposed between the first sheet and the second sheet,

an excretion surface on which a pet excretes, and

a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region,

a guiding part which covers the first and second adhesion regions and is provided such that the first and second adhesion regions are exposed in predetermined order,

adhesive force in the first adhesion region is rendered weaker than adhesive force in the second adhesion region, whereby the first adhesion region is formed in a different manner from the second adhesion region,

the adhesion region comprises an adhesive region having an adhesive applied thereto,

the guiding part is configured such that the first adhesion region is exposed first and the second adhesion region is exposed next,

the guiding part has a release sheet arranged on at least part of the adhesion region, and the release sheet has one side and the other side opposite to the one side,

the release sheet has an inhibiting region for inhibiting adhesion to the adhesion region,

the release sheet has a promoting region for promoting adhesion to the adhesion region,

the release sheet has the inhibiting region on the one side,

in the release sheet attached to the adhesion region, the inhibiting region has a first inhibiting region which is removably attached to the first adhesion region, and a second inhibiting region which is removably attached to the second adhesion region,

the guiding part is configured such that the first inhibiting region is first removed from the first adhesion region and then the second inhibiting region is removed from the second adhesion region,

further comprising a pet sheet folding part along which the pet absorbent sheet is folded between the first adhesion region and the second adhesion region, and

the release sheet has a release sheet middle folding part along which the release sheet attached to the adhesion region is folded at a region facing the pet sheet folding part.

(10)

The pet absorbent sheet as defined in (9), wherein:

the inhibiting region of the release sheet has a first inhibiting region on the one side and a second inhibiting region on the other side, and

the first inhibiting region is attached to the first adhesion region and the second inhibiting region is attached to the second adhesion region.

(11)

The pet absorbent sheet as defined in (10), wherein:

the release sheet has the promoting region on the one side,

the promoting region is attached to a region on the second adhesion region which is separated from the first adhesion region in a positional relation between the first adhesion region and the second adhesion region in the pet absorbent sheet ready to be attached to the placing object, and

the release sheet is folded back along a second release sheet folding part, whereby the one side faces the first adhesion region.

(12)

The pet absorbent sheet as defined in (10), wherein:

the release sheet has the promoting region on the other side, and

the promoting region is attached to a region on the second adhesion region which is separated from the first adhesion region in a positional relation of the first adhesion region and the second adhesion region in the pet absorbent sheet ready to be attached to the placing object.

(13)

The pet absorbent sheet as defined in (1), wherein the guiding part comprises a display part formed on the release sheet.

(14)

The pet absorbent sheet as defined in (13), wherein the display part has an indication that the first adhesion region is exposed first and then the second adhesion region is exposed.

(15)

The pet absorbent sheet as defined in (14), wherein:

the release sheet has a first release sheet which is attached to the first adhesion region, and a second release sheet which is attached to the second adhesion region, and

the display part has a first display part formed on the first release sheet and a second display part formed on the second release sheet.

(16)

The pet absorbent sheet as defined in any one of (1) to (15), wherein an inward direction from an end region toward a central region of the pet absorbent sheet and an outward direction from the central region toward the end region are defined, and a pair of the first and second adhesion regions adjacent to each other forms an adjacent adhesion region.

(17)

The pet absorbent sheet as defined in (16), wherein a plurality of such adjacent adhesion regions are formed, and in a plurality of the adjacent adhesion regions, the first adhesion region is arranged in an outward region in the outward direction.

(18)

The pet absorbent sheet as defined in (16), wherein a plurality of such adjacent adhesion regions are formed and the first adhesion region and the second adhesion region are arranged in the same order in an arrangement direction in the adjacent adhesion regions.

### DESCRIPTION OF NUMERALS

100, 1001, 1002, 1003, 1004, 1005, 1006, 1007, 1008 pet absorbent sheet
110C corner
100C1 corner region
100H arrangement direction
100S outward direction
100U inward direction
100X lateral end
100Y longitudinal end
110 top sheet (first sheet)
120 back sheet (second sheet)
130 absorbing core
140 excretion surface
150 placing surface
160 entire folding line
161 pet sheet folding part
200 adhesion region
200A adjacent adhesion region
200B middle region
210 first adhesion region
211 adjacent end
2111 adjacent end region
212 farther end
2121 farther end region
220 second adhesion region
221 adjacent end
2211 adjacent end region
222 farther end
2221 farther end region
230 adhesive
231 adhesive region
300 release sheet
300A first release sheet
300B second release sheet
310 first release sheet surface (one side)
320 second release sheet surface (the other side)
330 release sheet body
340 inhibiting region
341 first inhibiting region
342 second inhibiting region
350 promoting region
360 end
361 removal starting end
361A removal starting region
362 fixed end
362A fixed region
371 first release sheet folding part
372 release sheet middle folding part
373 second release sheet folding part
400 guiding part
410 display part
411 first display part
412 second display part
X lateral direction
Y longitudinal direction

1. A pet absorbent sheet, comprising:
a liquid-permeable first sheet,
a liquid-impermeable second sheet,
an absorbing core disposed between the first sheet and the second sheet, an excretion surface on which a pet excretes, and
a placing surface opposite to the excretion surface, wherein the placing surface has an adhesion region which has an adhesive applied thereto and can adhere to a placing object, and the adhesion region has a first adhesion region and a second adhesion region formed in a different manner from the first adhesion region, and
a guiding part which covers the first and second adhesion regions and is provided such that the first and second adhesion regions are exposed in predetermined order.

2. The pet absorbent sheet as defined in claim 1, wherein adhesive force in the first adhesion region is rendered weaker than adhesive force in the second adhesion region, whereby the first adhesion region is formed in a different manner from the second adhesion region.

3. The pet absorbent sheet as defined in claim 1, wherein the guiding part is configured such that the first adhesion region is exposed first and the second adhesion region is exposed next.

4. The pet absorbent sheet as defined in claim 1, wherein the guiding part has a release sheet arranged on at least part of the adhesion region, and the release sheet has one side and the other side opposite to the one side.

5. The pet absorbent sheet as defined in claim 4, wherein the release sheet has an inhibiting region for inhibiting adhesion to the adhesion region.

6. The pet absorbent sheet as defined in claim 4, wherein the release sheet has a promoting region for promoting adhesion to the adhesion region.

7. The pet absorbent sheet as defined in claim 1, further comprising a pet sheet folding part along which the pet absorbent sheet is folded between the first adhesion region and the second adhesion region.
